(19) United States
(12) Patent Application Publication
(10) Pub. No.: US 2006/0277413 A1
(43) Pub. Date: Dec. 7, 2006

(54) Data security

(76) Inventor: Dennis T. Drews, Phoenix, AZ (US)

Correspondence Address: Squire, Sanders & Dempsey, L.L.P.;Suite 2700, Two Renaissance Squire, 40 North Central Avenue, Phoenix, AZ, 85004-4498, US

(21) Appl. No.: 11/441,500

(22) Filed: May 26, 2006

Related U.S. Application Data
(60) Provisional application No. 60/686,671, filed on Jun. 1, 2005.

(51) Int. Cl. G06F 12/14

(52) U.S. Cl. 713/189

(57) ABSTRACT

Data Security methods, computer programs, and systems for encrypting and decrypting data, process sharing, and redundancy. The invention provides techniques for encryption including the encryption of a structured data file where each smallest unit of the data file (e.g., a field in a database record) is encrypted separately. The invention also provides techniques for decrypting such an encrypted data file. Requested fields of data are decrypted, stored in temporary memory, and displayed to the user or used to complete a task. Once the display is over or the task is completed, the decrypted data in temporary memory is deleted. The invention also provides techniques for real time process sharing and redundancy that utilize system characteristics to determine the apportionment of processes.

### CROSS REFERENCE TO RELATED APPLICATIONS

This application claims the benefit of U.S. Provisional Application No. 60/686,671 filed Jun. 1, 2005, the contents of which are hereby incorporated by reference herein.

### DESCRIPTION OF THE INVENTION

1. Field of the Invention

The present invention relates generally to data security, and more specifically to a method, system and computer program for encrypting and decrypting data, process sharing, and redundancy.

2. Background of the Invention

Currently, data and identity theft are large threats to individuals, corporations, governments, and other organizations. Data stored on Internet servers, home personal computers, and business governmental databases are all targets. Conventional solutions for data protection have generally been unacceptable in preventing data and identity theft.

Conventional methods and techniques for protecting data typically involve one or more layers of protection designed to prevent access to data. Such layers of protection may include identification cards, passwords, firewalls, biometric identification, and other techniques to verify that an entity (e.g., an individual or other electronic device) attempting to access the data is allowed to view, use, and/or obtain that data. However, if these layers of protection are circumvented, a thief often gains access to data that is easily copied and interpreted. This is because conventional data security techniques often only protect access to data, but leave the data itself as plaintext (i.e., unencrypted).

The encryption of data is well known, however conventional encryption techniques for databases are often impractical. This is especially the case for large databases. Entire databases may be encrypted, but the process for accessing and updating such an encrypted database becomes impractically long. As such, live data (i.e., data that is potentially or currently in use) stored on databases is often left unencrypted. Conventional encryption techniques have also been applied to backup data files and transmitted data.

Data backup is another important aspect of data security. Data is typically stored in more than one location in case one location suffers a catastrophic failure. However, conventional data backup systems often only back up data at predetermined intervals (e.g., once every day). As such, data that is newly stored between backups is vulnerable to being lost. In addition, when utilizing other computer systems only as backup systems, their resources are essentially wasted in between backup cycles. Shorter backup intervals may be employed, but this typically results in an unacceptable lowering of computer performance, especially when either the main computer or backup computer is experiencing heavy usage or network delays.

### SUMMARY OF THE INVENTION

In view of the foregoing, the present invention provides a method, system and computer program for data encryption and decryption, process sharing, and redundancy.

According to various aspects, the present invention provides methods and techniques for encrypting data into and decrypting data from a data file. The data file may be any file that has one or more definable locations for storing data. As one example, a data file may be a database that contains multiple records, each record having one or more fields for storing data. Rather than encrypting the entire database as a whole, each field or record (or group of fields or records) is individually encrypted using any data encryption technique. Each field may be encrypted with its own unique encryption key(s). Data stored in such a data file is encrypted and not plaintext, and as such, theft of such an encrypted structured data file becomes less worrisome since breaking encryption codes is enormously difficult.

Decryption of the encrypted data stored in such a data file may be handled field by field or record by record. As such, decryption of such an encrypted data base is typically faster than decrypting a database that was encrypted as a whole. This is because users typically only desire to access a few fields or records in the database at a time and not the whole database. As such, when specific data is requested from the encrypted database, only those fields and/or records that were requested are decrypted. This is possible because each field (or groups of fields) were encrypted individually.

According to one aspect of the invention, users of a system are associated with certain decryption keys. As one example, users may be associated with decryption keys through a user profile stored on a computer. When a user accesses the system (e.g., through a password or other identification means) that user would be allowed to access predetermined types of fields and/or records that are able to be decrypted by that user's associated encryption/decryption keys.

According to another aspect of the invention, in order to further discourage data theft, data accessed by a user is not permanently saved at any location in plaintext. Rather, the decrypted plaintext is displayed on a screen and/or saved in temporary memory until the user's task is completed. Then the decrypted plaintext is deleted. In this way, even if a thief had obtained access to an authorized user's account, the thief would only have access to the types of data (e.g., certain predetermined fields and/or records) that user was authorized to access. In addition, a thief would only be able to visually view the plaintext data and would not be able to copy plaintext data electronically.

According to yet another aspect of the invention, the encryption/decryption techniques may be employed through a distributed computer system. That is, one or more requesting devices may request access to and/or update encrypted data that is redundantly stored on one or more server computers. When requesting access to data and/or an update of the encrypted data, each requesting device determines which of the one or more servers is able to handle the request. The determination may be based on the current load of the server, expected network delays, a time to reply to the determination, a time to send the request to the server, and/or a time to execute the request. If it is determined that a server does not meet certain predetermined thresholds, the requesting device skips that server and then performs the determination on other servers until it finds one able to handle the request.

In addition to this real time process sharing, other aspects of the invention include real time redundancy processes. For example, a request (e.g., a request to amend or add data) that is handled by one server is sent by that server to each of the other servers in the distributed system so that each server may have identical data.

According to one embodiment, the invention provides a method of creating a data file containing encrypted data. The method includes the steps of receiving a plaintext data file having one or more data structures, each data structure having one or more fields containing plaintext data, encrypting each field of plaintext data with an encryption algorithm to create encrypted data, creating an encrypted data file, and storing the encrypted data in the fields of the encrypted data file.

According to another embodiment, the invention provides a method for decrypting an encrypted data file. The method includes the steps of providing an encrypted data file, the encrypted data file having two or more data structures, each data structure having one or more fields containing encrypted data, receiving a request to decrypt encrypted data in one or more of the fields, decrypting the requested data into plaintext data, and displaying the decrypted plaintext data.

According to yet another embodiment, the invention provides a method for sharing processes among two or more networked computers. The method includes the steps of (1) receiving a request to execute a process, (2) determining if a networked computer N is within a predetermined activity threshold, (3) executing the process with the first networked computer if it is determined to be within the predetermined activity threshold, and (4) repeating steps (2) to (4) with respect to networked computer N+1 if networked computer N is not within the predetermined activity threshold.

According to another embodiment, the invention provides a method for redundantly storing data among a plurality of networked computers. The method includes the steps of executing a process on a first computer, wherein the process amends, adds, and/or deletes data stored on the first computer, determining if any of one or more of a second group of computers, other than the first computer, are within a predetermined activity threshold, sending instructions to execute the process to each computer of the second group of computers determined to be within the predetermined activity threshold, and placing instructions to execute the process in a queue for each computer in the second group of computers determined not to be within the predetermined activity threshold. The method may further includes the steps of executing the queued process in the second group of computers determined not to be within the predetermined activity threshold if they return within a predetermined activity threshold before a predetermined length of time, and replacing all data stored on the second group of computers determined not to be within the predetermined activity threshold with data stored on one of the plurality of networked computers that is within a predetermined activity threshold if the predetermined length of time has elapsed and processes remain in the queue.

It is to be understood that the descriptions of this invention herein are exemplary and explanatory only and are not restrictive of the invention as claimed.

### BRIEF DESCRIPTION OF THE DRAWINGS

FIG. 1 is a block diagram of one embodiment of the invention in its normal operating environment.

FIG. 2 of a block diagram of a computer system.

FIG. 3 is a functional block diagram of data security module according to one embodiment of the invention.

FIG. 4 is a flowchart of a check tolerance function according to one embodiment of the invention.

FIG. 5 is flowchart of an ODBC search function according to one embodiment of the invention.

FIG. 6 is a flowchart of a Post Events function according to one embodiment of the invention.

FIG. 7 is a flowchart of an ODBC pack function according to one embodiment of the invention.

FIG. 8 is a flowchart of an open database function according to one embodiment of the invention.

FIG. 9 is a flowchart of a close database function according to one embodiment of the invention.

FIG. 10 is a flowchart of an ODBD read function according to one embodiment of the invention.

FIG. 11 is a flowchart of a structure read function according to one embodiment of the invention.

FIG. 12A is a flowchart of a save ODBD function according to one embodiment of the invention.

FIG. 12B is a continuation of the flowchart for the save ODBD function according to one embodiment of the invention.

FIG. 13 is a flowchart of a save structure function according to one embodiment of the invention.

FIG. 14 is a flowchart of a redundancy server status function according to one embodiment of the invention.

FIG. 15 is a flowchart of a server tolerance function according to one embodiment of the invention.

FIG. 16 is a flowchart of an assume processes function according to one embodiment of the invention.

FIG. 17 is a flowchart of a restore processes function according to one embodiment of the invention.

FIG. 18 is a flowchart of a decryption function according to one embodiment of the invention.

FIG. 19 is a flowchart of an encryption function according to one embodiment of the invention.

FIG. 20 is a flowchart of a read communications function according to one embodiment of the invention.

FIG. 21 is a flowchart of a write communications function according to one embodiment of the invention.

FIG. 22 is a flowchart of a create socket function according to one embodiment of the invention.

FIG. 23 is a flowchart of an accept connection function according to one embodiment of the invention.

FIG. 24 is a flowchart of a close socket function according to one embodiment of the invention.

FIG. 25 is a flowchart of a route check function according to one embodiment of the invention.

FIG. 26 is a flowchart of an alarm even processing function according to one embodiment of the invention.

FIG. 27 is a flowchart of an access control processing function according to one embodiment of the invention.

FIG. 28 shows a schematic of a Data Security system according to various aspects of the invention.

FIG. 29 shows a schematic of a Data Security system with example requesting devices according to various aspects of the invention.

FIG. 30A is a flowchart showing steps for creating encrypted data according to various aspects of the invention.

FIG. 30B is a flowchart showing steps for creating pointers to encrypted data according to various aspects of the invention.

FIG. 30C is a flowchart showing steps of creating an encryption key data file according to various aspects of the invention.

FIG. 31 is a visual representation of a relational database.

FIG. 32 is a visual representation of a structural database.

FIG. 33A shows the data flow for creating an encrypted data file according to various aspects of the invention.

FIG. 33B shows the data flow for creating a pointer data file according to various aspects of the invention.

FIG. 34A is a flowchart showing steps for decrypting data according to various aspects of the invention.

FIG. 34B is a flowchart showing steps for decrypting data using a pointer data file according to various aspects of the invention.

FIG. 34C is a flowchart showing steps for decrypting data with encryption/decryption keys associated to a user according to various aspects of the invention.

FIG. 34D is a flowchart showing steps for decrypting data with encryption/decryption keys associated to a user through a logon process according to various aspects of the invention.

FIG. 35 shows a flowchart of a process sharing method according to one embodiment of the invention.

FIG. 36 shows a flowchart of a redundancy method according to one embodiment of the invention.

### DETAILED DESCRIPTION

Reference will now be made in detail to the present exemplary embodiments of the invention, examples of which are illustrated in the accompanying drawings.

The present invention provides a method, system and computer program for data security, including encryption and decryption techniques, process sharing techniques, and redundancy techniques.

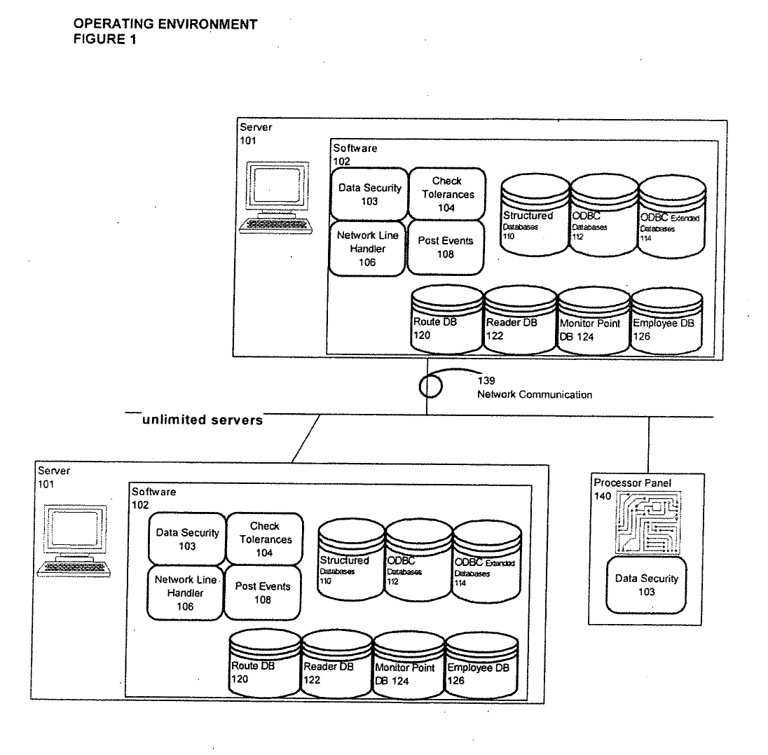

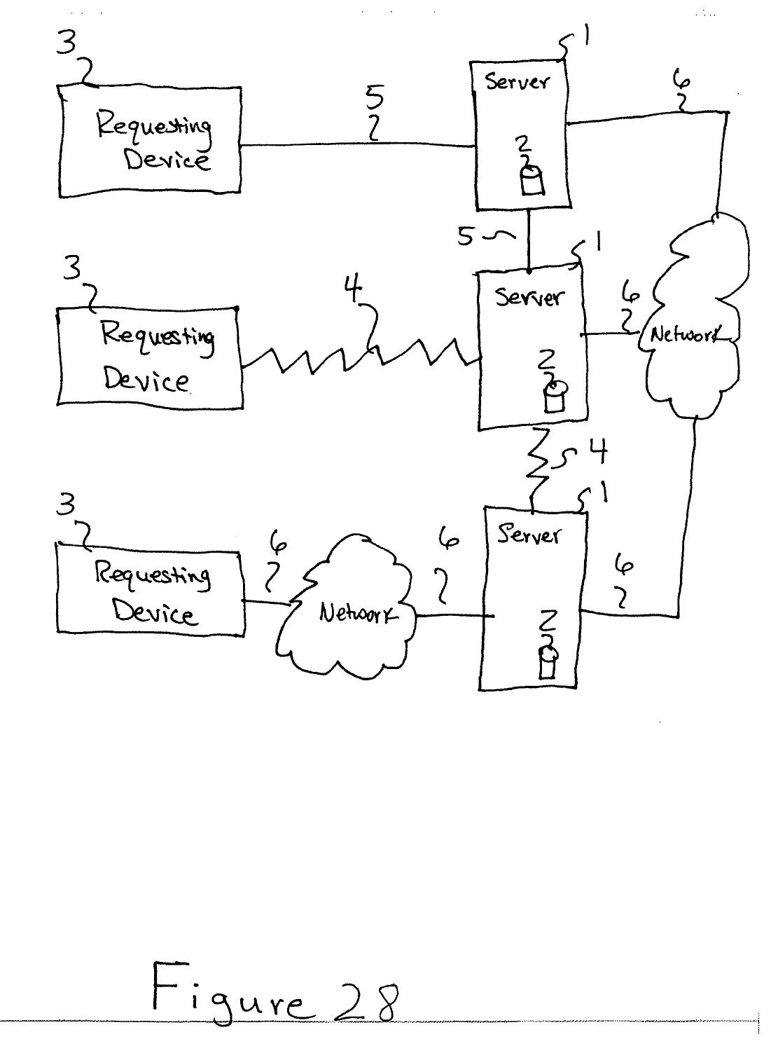

FIG. 28 shows a schematic of a data security system according to various aspects of the invention. The methods, techniques, and systems for encrypting and decrypting data, process sharing and redundancy are preferably performed in utilizing a computer system, including a networked system with one or more computers and/or data processing devices. As shown in FIG. 1, one example system may include one or more servers 1 that each contains a data storage unit 2.

Servers 1 may be any type of computing device including personal computers, network servers, and/or purpose-built machines for performing the methods of the invention described below. The one or more servers 1 may be connected to each other in any way that allows for the transfer of data and/or instructions, including connections via a local area network (LAN) connection 5, a wireless connection 4, and/or an Internet/WAN connection 6. These connections allow the redundant storage of data on all of data storage units 2 as well as for process sharing.

Data storage units 2 may be any type of media for storing data. Such media may include flash memory, hard disk drives, optical drives, magnetic tape, CD-ROM, DVD-ROM, rewriteable CD's, rewriteable DVD, etc. The data stored on data storage units 2 is preferably encrypted according to methods and techniques and are preferably in a data format as is described in more detail below.

Servers 1 may be connected to one or more requesting devices 3 through any connection that allows for the transfer of data and/or instructions. Such connections may include a LAN connection 5, wireless connection 4, and/or Internet/WAN connection 6. Requesting device 3 is any device capable of requesting access to, update of, and/or some manipulation of data stored on data storage units 2. In this regard, servers 1 may also be requesting devices. Servers 1 may request access to, update of, and/or manipulation of data stored in a data storage unit contained in the requesting server or in another server connected to the system.

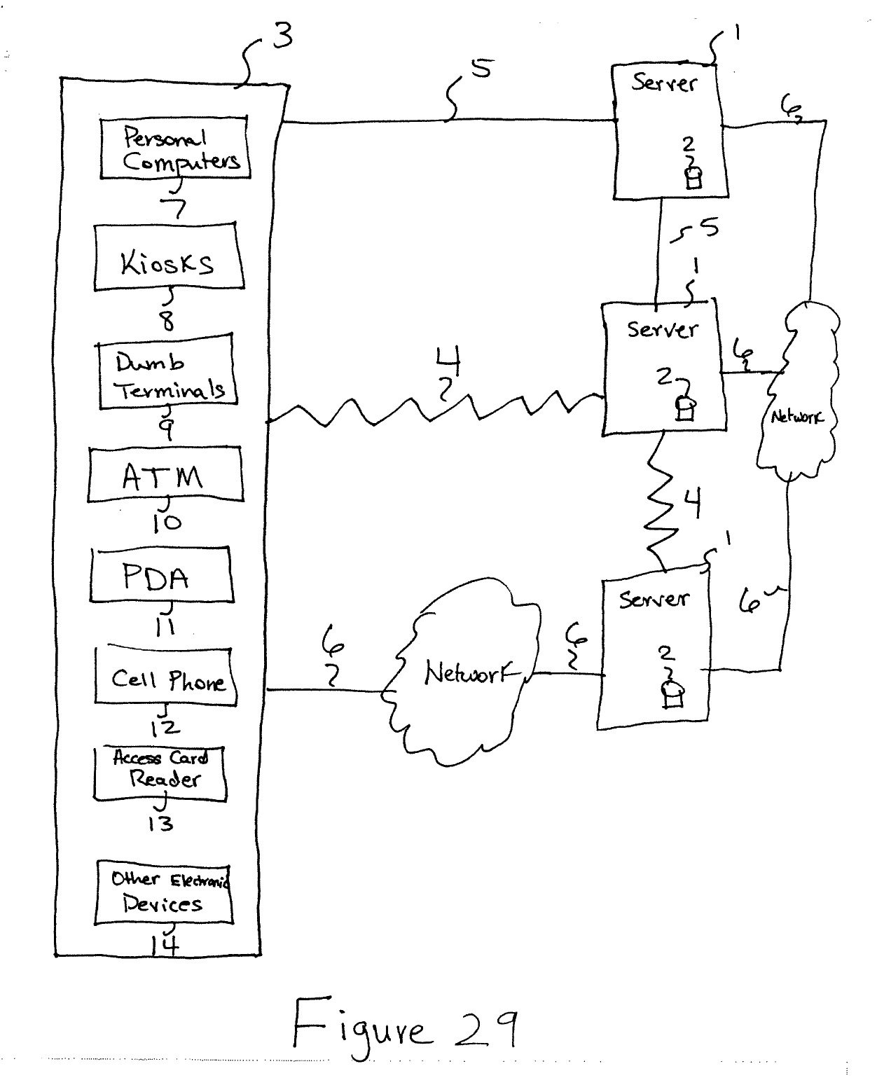

FIG. 29 shows a schematic of a data security system with example requesting devices according to various aspects of the invention. Requesting devices 3 may include personal computers 7, kiosks 8, dumb terminals 9, automatic teller machines (ATM) 10, personal data assistants (PDA) 11, cell phones 12, access card readers 13 or other electronic devices 14. The following are some example implementations utilizing the requesting device. These examples are demonstrative and only, and in no way should be interpreted to limit the scope of the invention.

Personal computer 7 may be used for accessing a user's credit card data stored on a server (e.g., the server of a credit card company) connected to the personal computer through a LAN and/or Internet/WAN connection. Kiosk 8 may be used to allow a user to access flight and boarding ticket data stored on a server (e.g., the server of an airline) connected to the kiosk through a LAN or Internet/WAN connection. ATM 10 may be used to access a customer's bank account data stored on a server (e.g., the server of a bank) connected to the ATM through a LAN or Internet/WAN connection. PDA 11 or cell phone 12 may be used to access a user's e-mail stored on a server (e.g., an e-mail server) connected to the PDA or cell phone through a wireless and/or Internet/WAN connection. Access card reader 13 may be used to request verification of a user's identification information (e.g., a magnetic card) to entry control data stored on a server connected to the access card reader through a LAN and/or Internet/WAN connection.

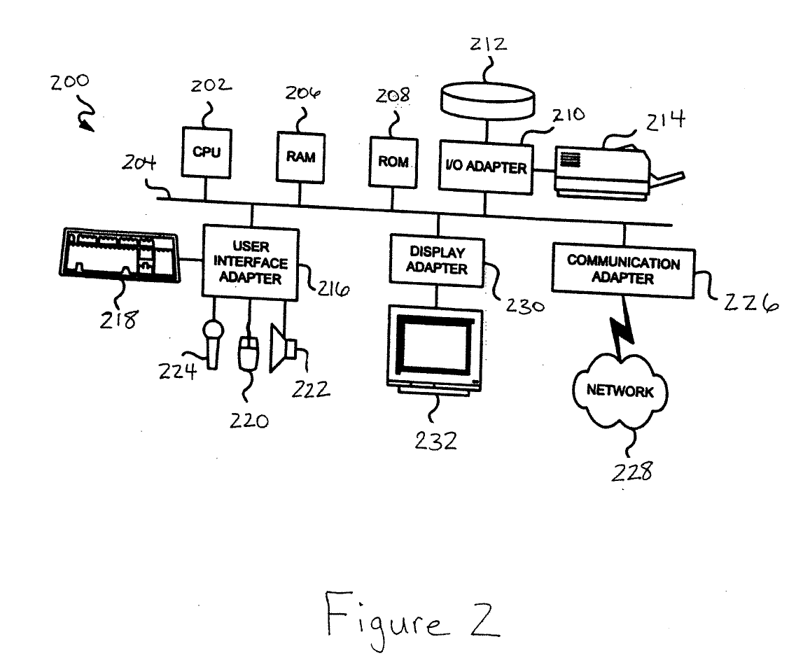

As discussed above with reference to FIGS. 28 and 29, the data security methods and techniques of the invention may be implemented in a computer environment, through software programs and/or purpose-built hardware units. FIG. 2 shows an exemplary hardware configuration of a computer system 200. Computer system 200 has one or more central processing units 202, such as a microprocessor, and a number of other units interconnected via a system bus 204.

The computer system shown in FIG. 2, computer system 200 may include a Random Access Memory (RAM) 206, Read Only Memory (ROM) 208, and an I/O adapter 210 for connecting peripheral devices such as, for example, disk storage units 212 and printers 214 to the bus 204. Computer system 200 also includes a user interface adapter 216 for connecting various user interface devices such as, for example, a keyboard 218, a mouse 220, a speaker 222, a microphone 224, and/or other user interface devices such as a touch screen or a digital camera to the bus 204. Computer system 200 may further include a communication adapter 226 for connecting the computer system 200 to a communication network 228 (e.g., wireless network, a LAN network, the Internet/WAN, etc.) and a display adapter 230 for connecting the bus 204 to a display device 232.

Computer system 200 may utilize an operating system such as the Microsoft Windows Operating System (OS), the IBM OS/2 operating system, the MAC OS, the UNIX/Linux operating system, and/or a purpose-built operating system for implementing the Data Security techniques of the invention. Those skilled in the art will appreciate that the present invention may also be implemented on platforms and operating systems other than those mentioned. An embodiment of the present invention may also be written using any programming language, including but not limited to Java, C, and the C++ language and may utilize object oriented programming methodology.

Computer system 200 may utilize Transmission Control Protocol/Internet Protocol (TCP/IP) as the communication language for accessing the Internet. TCP/IP may also be used as a communications protocol in the private networks called intranet/LAN and in extranet/WAN. TCP/IP is a two-layering program. The higher layer, Transmission Control Protocol (TCP), manages the assembling of a message or file into smaller packets that are transmitted over the Internet and received by a TCP layer that reassembles the packets into the original message. The lower layer, Internet Protocol (IP), handles the address part of each packet so that it gets to the right destination. Each gateway computer on the network checks this address to see where to forward the message. Even though some packets from the same message are routed differently than others, they'll be reassembled at the destination. TCP/IP may use a client/server model of communication in which a computer user (a client) requests and is provided a service (such as sending a Web page) by another computer (a server) in the network. TCP/IP and the higher-level applications that use it may be considered “stateless” because each client request is considered a new request unrelated to any previous one (unlike ordinary phone conversations that require a dedicated connection for the call duration). Being stateless frees network paths so that everyone can use them continuously. Protocols related to TCP/IP include the User Datagram Protocol (UDP), which is used instead of TCP for special purposes. Other protocols are used by network host computers for exchanging router information. These include the Internet Control Message Protocol (ICMP), the Interior Gateway Protocol (IGP), the Exterior Gateway Protocol (EGP), and the Border Gateway Protocol (BGP).

Servers 1 and requesting devices 3 (each possibly implemented as a computer system 200) may utilize wireless connections for communication. Wireless connections may refer to a communications, monitoring, or control system in which electromagnetic radiation spectrum or acoustic waves carry a signal through atmospheric space rather than along a wire. In wireless systems, radio frequency (RF) or infrared transmission (IR) waves may be used. Common examples of wireless equipment in use today include the Global Positioning System (GPS), cellular telephone phones and pagers, cordless computer accessories and wireless LAN (WLAN). Wi-Fi (short for “wireless fidelity”) is a high-frequency wireless local area network (WLAN). Wi-Fi is specified in the 802.11b specification from the Institute of Electrical and Electronics Engineers (IEEE) and is part of a series of wireless specifications together with 802.11, 802.11a, and 802.11g. All four standards use the Ethernet protocol and CSMA/CA (carrier sense multiple access with collision avoidance) for path sharing.

Encryption Techniques

One aspect of the invention includes techniques for encrypting data. In general, encryption is the process of altering data such that it becomes unreadable (i.e., the data no longer directly conveys its original meaning). The original meaning of the encrypted data is then only again readable by designated individuals or devices that are given special knowledge. This process is called decryption. Typically, data is encrypted using an algorithm (often called a cipher) that may be performed by hand or utilizing a device such as a computer. Likewise, decryption is an algorithm that essentially reverses the encryption process. The original data (before encryption) is often referred to as plaintext. Encrypted plaintext data is often referred to as ciphertext.

Two common types of encryption include symmetric key algorithms (often called private-key cryptography) and asymmetric key algorithms (often called public-key cryptography). In a symmetric key algorithm, the sender (e.g., server 1) and the receiver (e.g., requesting device 3) have identical encryption/decryption keys set up in advance. These keys are kept secret from all other parties. The sender uses the key for encrypting data, while the receiver used the same key for decrypting the data. Examples of symmetric key algorithms include Twofish, Serpent, Advanced Encryption Standard (AES), Blowfish, CAST5, RC4, Data Encryption System (DES), Triple DES (TDES), and International Data Encryption Algorithm (IDEA).

In an asymmetric-key algorithm, two separate keys are used. One key is published and available to the public. This “public” key enables any sender to perform encryption. The other key is kept private. This “private” key enables only the receiver to perform decryption. The identity of the private key is not deducible from its counterpart public key. Typically, public key techniques are much more computationally intensive than symmetric-key techniques.

For proper operation, a public key and its ‘owner’ must be repeatable and verifiable. If not, the encryption algorithm may function perfectly but still be insecure. Typically, some form of a public key infrastructure is used to associate a public key with its owner. Such infrastructures validate the owner/public key association through the use of a trusted third party. Such a third party may be in the form of a hierarchical certificate authority (e.g., X.509), a local trust model (e.g., simple public key infrastructure or SPKI), or a statistical ‘web of trust’ (e.g., PGP (pretty good privacy) and GPG (GNU privacy guard)). Examples of asymmetric-key encryption algorithms include Diffie-Hellman, DSS (Digital Signature Standard), ElGamal, Elliptic Curve techniques, password-authenticated key agreement techniques, paillier cryptosystem, and the RSA encryption algorithm. Examples of other protocols that at least partially use asymmetric-key algorithms include GPG, IKE (Internet key exchange), PGP, SSH (Secure Shell), SSL (Secure Socket Layer), IETF (Internet Engineering Task Force) standard TLS (Transport Layer Security), and SILC (Secure Internet Live Conferencing).

Asymmetric-key and symmetric-key algorithms are not always used alone. Some systems utilize both asymmetric and symmetric algorithms. Such systems include SSL, PGP and GPG, etc.

Through FIPS 140 (Federal Information Processing Standards Publication 140), the United States federal government has set guidelines for cryptographic (i.e., encryption and decryption) modules (both hardware and software) used by the government. The current version of the standard is FIPS 140-2 that was issued on 25 May 2001. The invention is also applicable with the new FIPS 140-3 standard. The FIPS 140 encryption standards are asymmetric public key/private key standards where the public key is issued by the U.S. government.

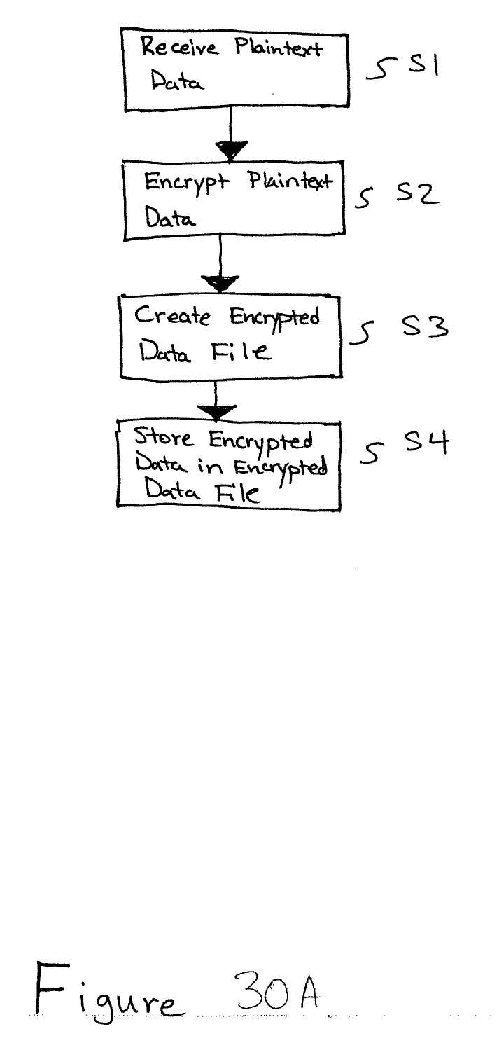

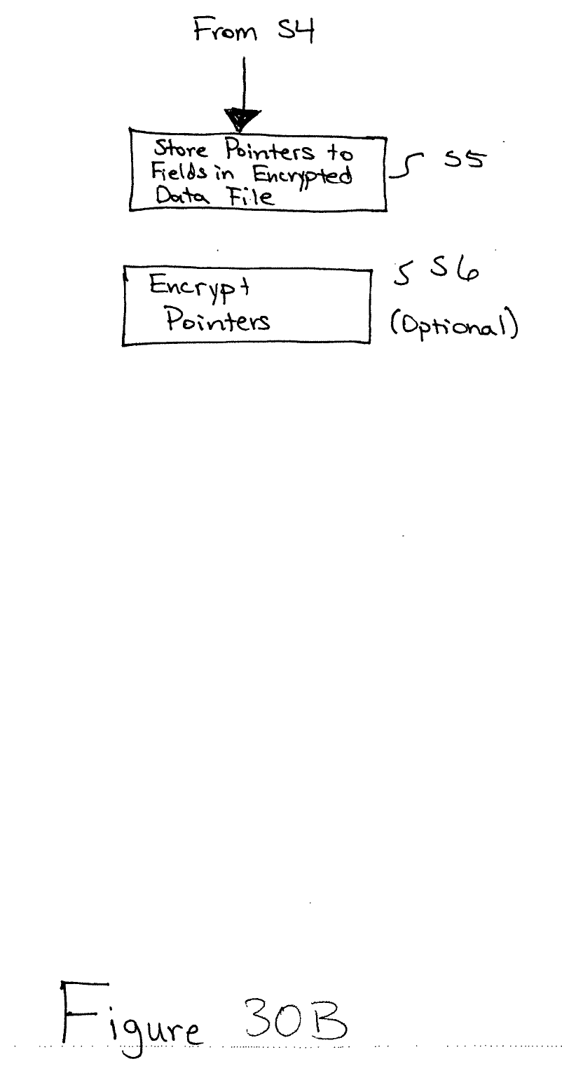

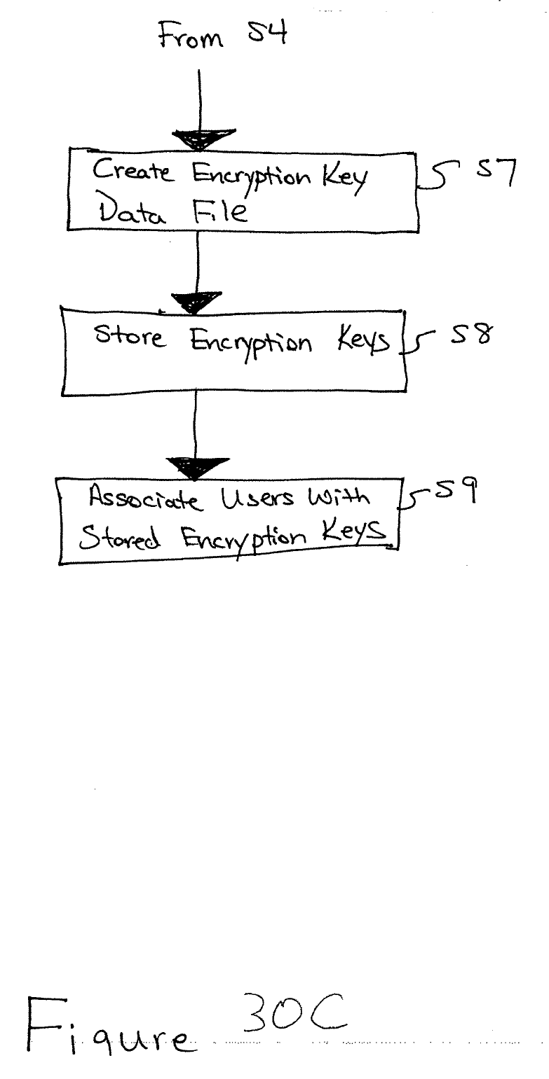

The methods and techniques of this invention may be conformed to operate with the FIPS 140-2/3 standard or any future amendments to the standards. In fact, the methods and techniques of the invention are applicable for use with any encryption standard, algorithm or protocol. FIGS. 30 to 33 describe how encryption algorithms are used according to various aspects of the invention.

Aspects of the invention may utilize the following techniques for encrypting data as part of a data security system. FIG. 30A is a flowchart showing steps for creating encrypted data according to various aspects of the invention. Initially in step S1, plaintext data is received. This plaintext data may be any data that is to be encrypted and subsequently stored in an encrypted format in a data file. The plaintext data may itself be a data file that is in a formatted data file. For example, the plaintext data file may be a relational database, structural database, or a delimited file (e.g., a tab delimited file). SQL files and ODBC (open database connectivity) are examples of relational database format, and .DAT files are examples of structural databases.

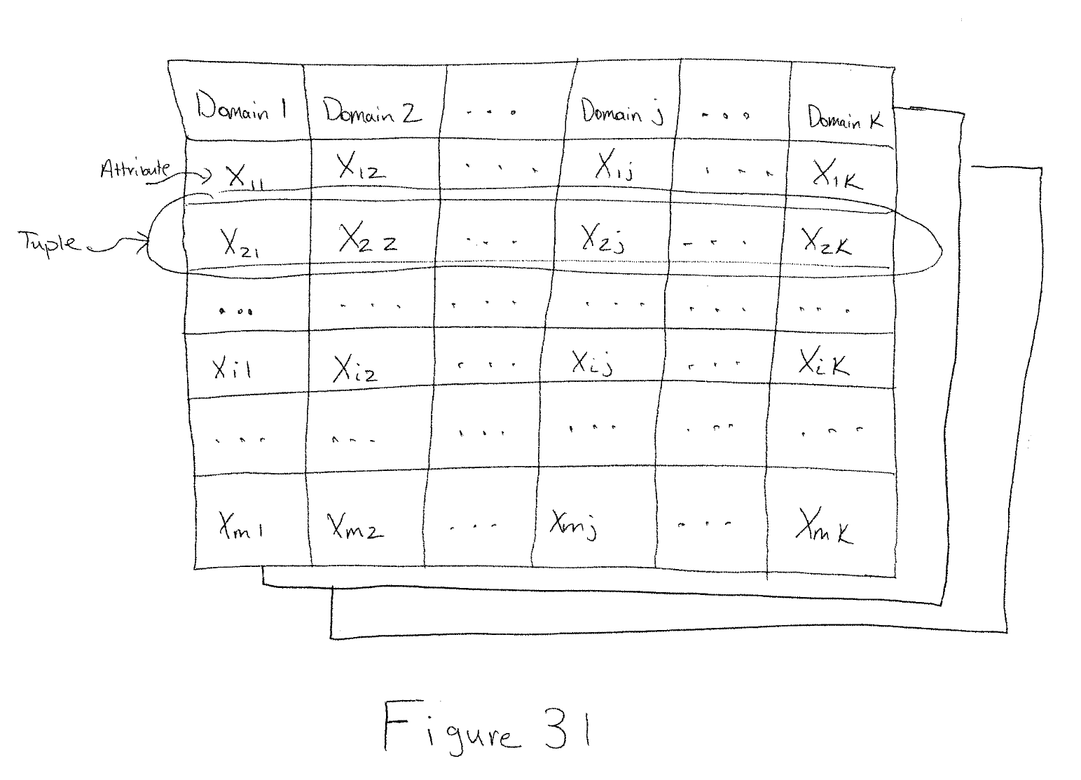

A relational database is a database structured in accordance with a relational model. Relational databases include one or more domains or data types. Under each domain are one or more attribute values. A set of attribute values is typically called a tuple. An attribute is an ordered pair of attribute name and type name. An attribute value is a specific value for the type of the attribute. FIG. 31 shows a visual representation of a relational database. As is shown, relational databases can be thought of as two or more tables with column headings (domain or data types) and rows (tuples). As one example, the domain values may indicate types of data, while each attribute (field) in the tuple (record) contain the data. Structured Query Language (SQL) is one example of database management software that is often used with relational databases.

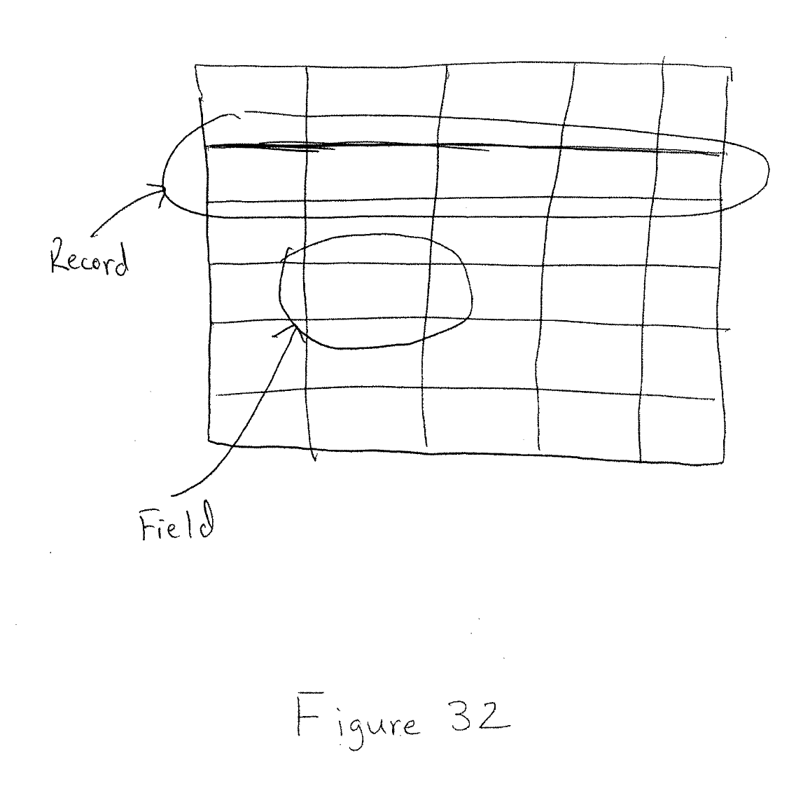

Structural databases can also be though of as tables, though unlike relational databases, structural databases include only one table. Each row of the table is referred to as a record. Each element in the record is referred to as a field. All fields in the same column contain the same type of data (e.g., name, social security number etc.). The data type for the fields is often included in a header file of the database. The fields in each record also have common characteristics (e.g., person, account, etc.). FIG. 32 shows a visual representation of a structural database.

Returning to FIG. 30 and step S1, in addition to structured or relational data formats, the received plaintext data may consist of a single piece of data intended to be stored in a single field of an encrypted data file. For example, the received plaintext data may accompany a request to amend data already stored in an encrypted file or add new data to an encrypted file.

Next in step S2, the plaintext data is encrypted utilizing an encryption algorithm. As discussed above, any encryption algorithm may be used.

Preferably, each smallest unit of the plaintext data file is encrypted separately. For example, a structural database may consist of one or more records, each record having a plurality of fields. As such, each field of data would be encrypted separately. In the case of a relational database, each attribute value would be encrypted separately. However, the invention is not limited to encrypting the smallest unit of data separately. In some applications, it may be beneficial to encrypt multiple fields (or attributes) together or to even encrypt multiple records (or tuples) together. However, when multiples fields, attributes, records or tuples are encrypted together, they then must be decrypted together to retrieve plaintext data. As such, it may be most beneficial to group units of data in situations where multiple units are likely to be often accessed together as a group.

As shown in step S2, each unit of plaintext data is encrypted separately. For example, each field may be encrypted with its own unique encryption key. Additionally, one key may be used for many different fields, for an entire record, or for groups of records. Furthermore, step S2 may perform several layers of encryption. For example, each field in a record may be encrypted individually with one or more unique keys, and then the entire record may be encrypted with its own key.

Next in step S3, an encryption data file is created. The encryption data file is a data file that will contain the encrypted plaintext data. The encryption data file may be in any format including a relational database, structural database, or a delimited file (e.g., a tab delimited file).

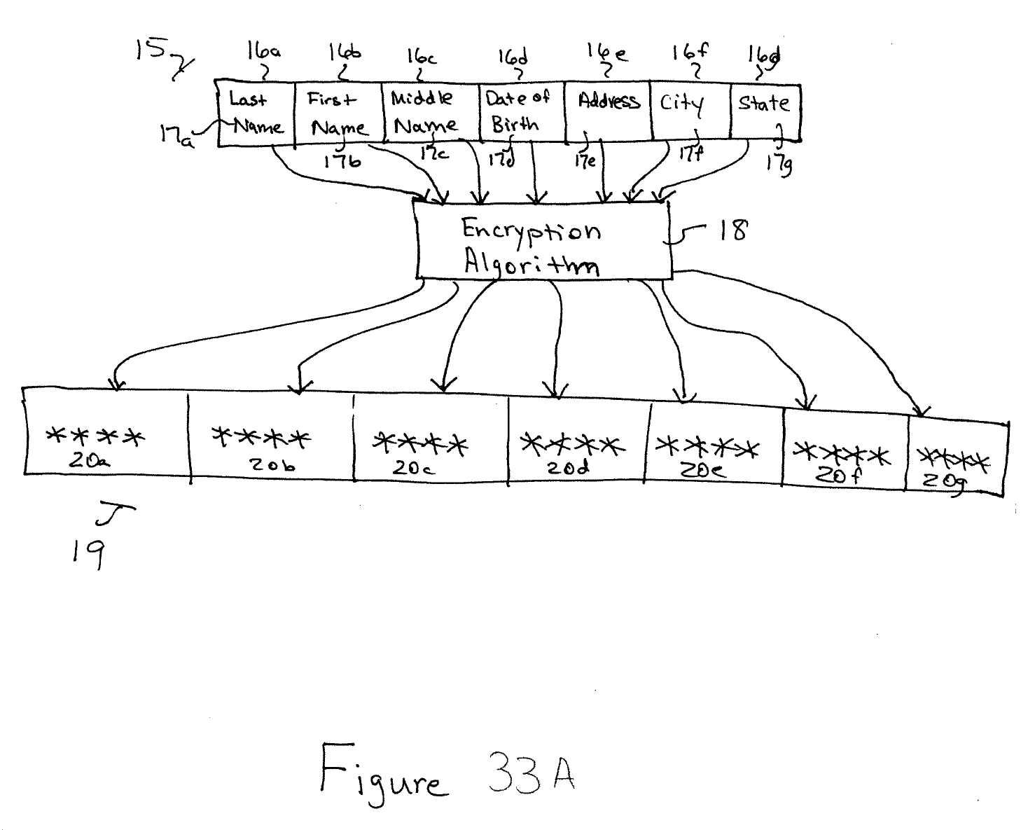

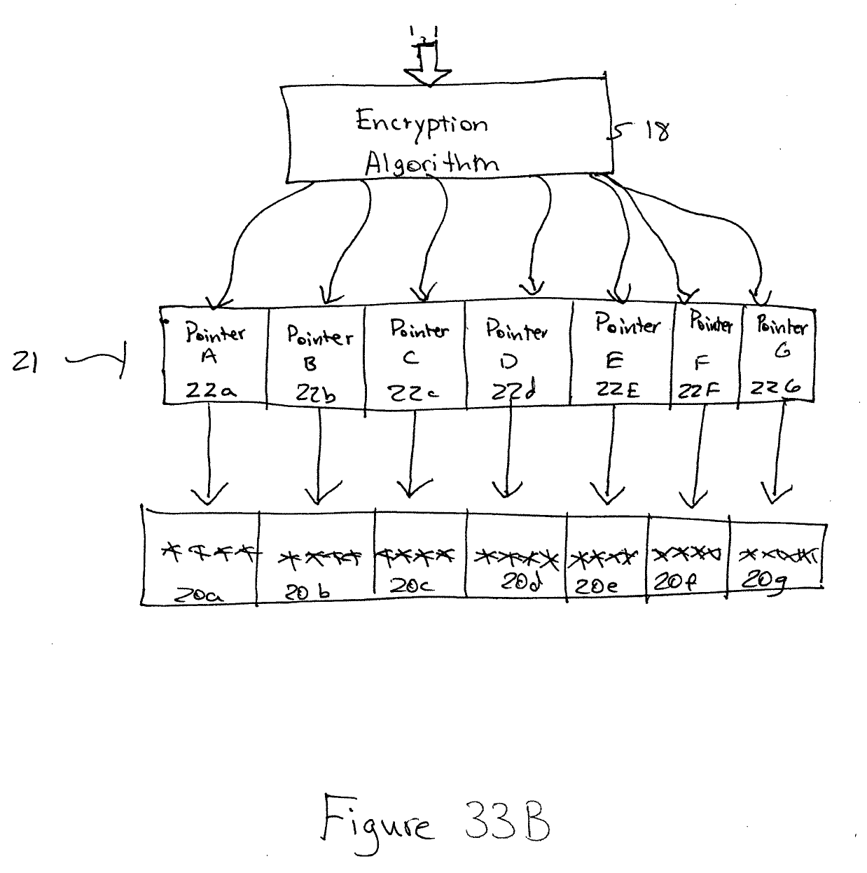

Then in step S4, the encrypted plaintext data is stored in the encrypted data file. FIG. 33A shows the data flow for creating an encrypted data file according to various aspects of the invention. In FIG. 33A, plaintext data 15 is shown as a record with fields 16a-g containing plaintext data 17a-g. Each field of plaintext data is encrypted with encrypting algorithm 18 and placed in fields of encrypted data file 19 as encrypted data 20a-g. Preferably, the plaintext data file 15 is deleted after it has been encrypted so that no stored plaintext data remains. In some cases, the encrypted data may be written into the original plaintext data file such that the plaintext data file becomes the encrypted data file.

However, reusing a plaintext data file is not always feasible. Many fields and records in conventional relational databases are of fixed data length (e.g., a fixed number of characters long). Since encryption algorithms generally create data that is generally much longer length than unencrypted data, it is likely that the fields and records of the plaintext data file would be unable to store the encrypted data. For example, a FIPS 140-2 based encryption algorithm may create encrypted data that is up to 128 characters longer that the plaintext. In this case, a new encrypted data file is created.

Even if an existing plaintext data file (e.g., a plaintext database) cannot be reused to store encrypted data, for some legacy database systems it may be beneficial to maintain the plaintext data file rather than deleting it. Instead, pointer data may be substituted into the fields of the plaintext data file. The pointer data gives the location of the encrypted plaintext data in the newly created encrypted data file. Utilizing a pointer database provides the further advantage of not needing to store the encrypted plaintext data linearly in the encrypted data file. Instead, the encrypted data may be stored in random locations since pointer data in a known file format (the legacy plaintext database) is used to locate the encrypted plaintext data. Pointer databases need not only be created from existing plaintext databases, but also may be newly created in conjunction with the encryption of data.

FIG. 30B is a flowchart showing steps for creating pointers to encrypted data according to various aspects of the invention. After the encrypted plaintext data is stored in the encrypted data file in step S4, in step S5, pointers to the location of the encrypted plaintext data in the encrypted data file are created and stored in a pointer data file. As mentioned above, the pointer data file may be the original plaintext data file or may be a newly created data file. Optionally, in step S6, the pointer data itself may also be encrypted.

FIG. 33B shows the data flow for creating a pointer data file according to various aspects of the invention. As shown in FIG. 33B, the pointer data may be created, stored, and/or encrypted by encryption algorithm 18. In addition, an algorithm separate from the encryption algorithm may be used to create the pointer data file. Pointer data file 21 includes pointer data 22a-g that points to the location of encrypted plaintext data 20a-g. As shown in FIG. 33B, the encrypted plaintext data was stored in successive fields of the encrypted data file. However, as mentioned above, when used in conjunction with a pointer data file, the encrypted plaintext data may be stored in the encrypted data file in any order and/or location.

FIG. 30C is a flowchart showing steps of creating an encryption key data file according to various aspects of the invention. The keys able to decrypt the plaintext data encrypted by encryption algorithm 18 in S2 are stored so that they may be recalled and used to decrypt the data. In step S7, after the encrypted plaintext data has been stored, an encryption key data file is created. In step S8, the keys needed to decrypt the data encrypted in step S2 are stored in the encryption data file. In step S9, a user and/or class of users is associated with each decryption key. This association may be stored in the encryption key data file or in another location. In this way, users of a system may be allowed to have access to only certain encrypted data fields.

Decryption

Other aspects of the invention relate to the decryption of a structured data file that was encrypted in the manner described above with reference to FIGS. 30-33. Decryption of the encrypted data file may be desired in order to view the data, make amendments to the data, or use the data to complete another task. For example, the following decryption processes may be utilized by an individual user to access their bank account data stored on an encrypted database. In this case, the individual user may only wish to view the data. As another example, an entry control system may utilize the following decryption processes to decrypt employee information in an encrypted data file to verify identification information (e.g., a magnetic card or biometrics) provided by an individual at a point of entry. In this case, it may not be necessary or wanted to display the decrypted employee information to the user, but rather the entry control system utilizes the decrypted data to perform verification.

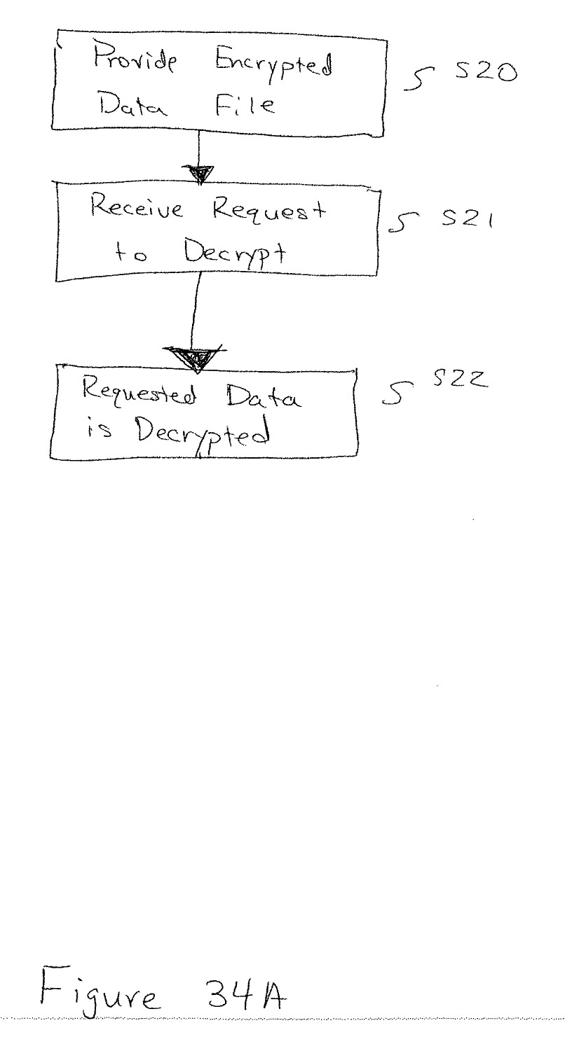

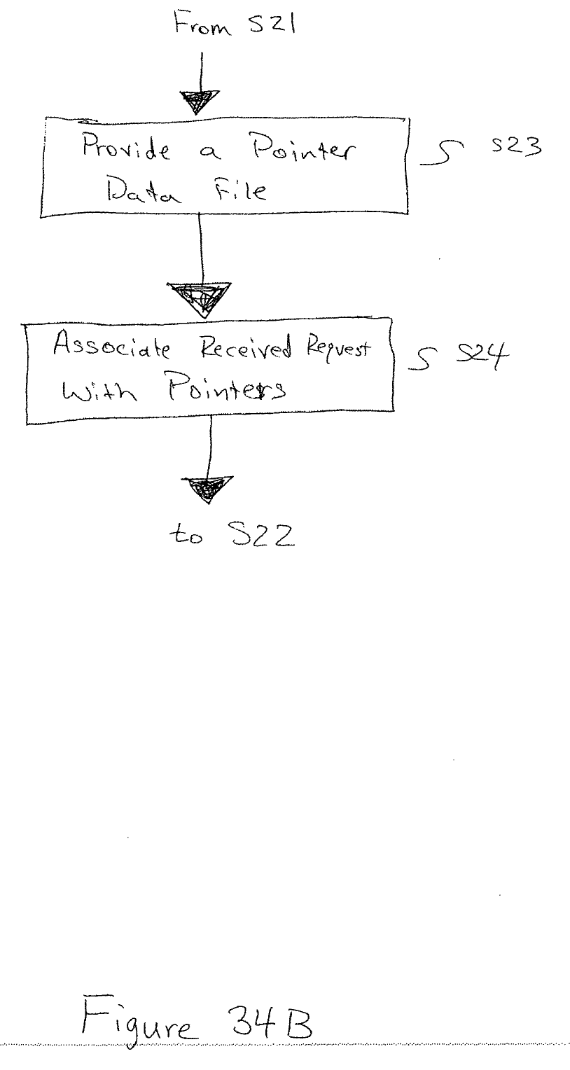

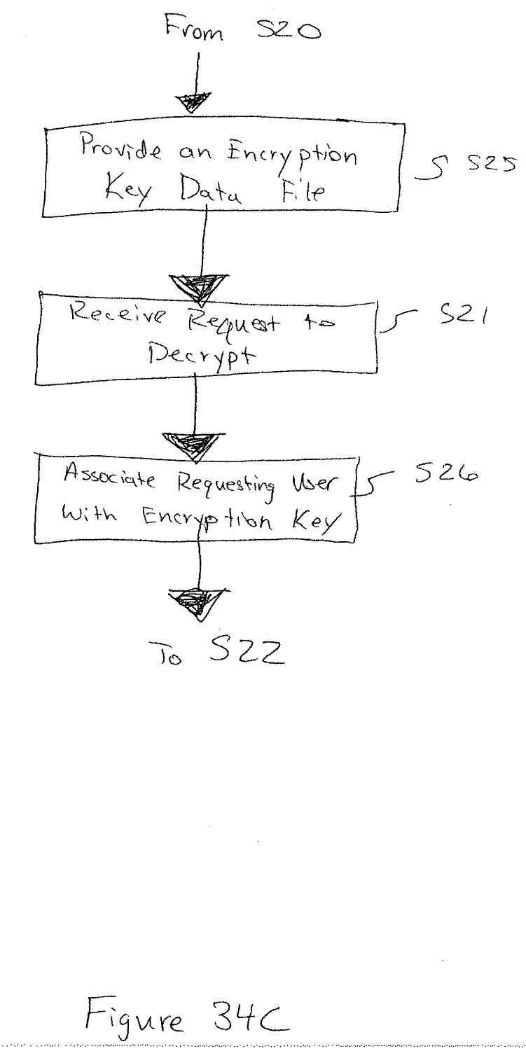

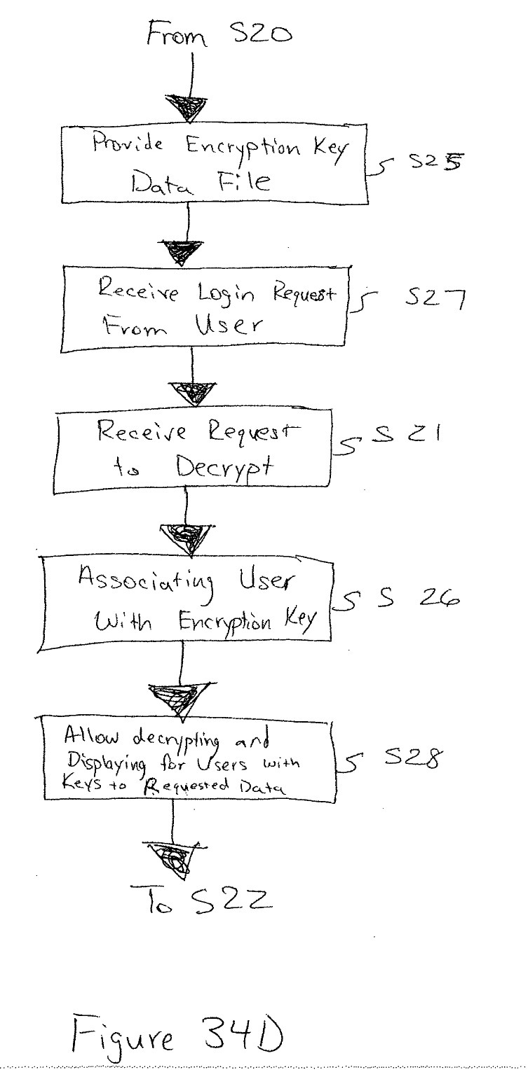

FIG. 34A depicts a flowchart showing a method for decrypting an encrypted data file according to one embodiment of the invention. In step S20, an encrypted data file is provided. The encrypted data file having two or more data structures, each data structure having one or more fields containing encrypted data. Preferably, the encrypted data file is one created with the processes described above with reference to FIG. 30-33. As before, the encrypted data file may be in any format including, but not limited to, structural databases, relational databases, and delimited files.

In step S21, a request to decrypt encrypted data in one more of the fields is received. This request may come from a user, a software program, or other electronic device (see requesting device 3 in FIG. 28).

In step S22, the requested data is decrypted into plaintext data. At this point, the data may be displayed or utilized to complete a task as described above. According to one aspect of the invention, if the decrypted data is displayed it is first stored in temporary memory, displayed, and then deleted. As such, the data is not permanently stored in plaintext form even when decrypted.

Turning now to FIG. 34B, the decryption method may further include the steps of providing a pointer data file (S23) and associating the received request with pointers in the pointer data file (S24). The pointer data file contains pointers to fields in the encrypted data file, and is preferably created utilizing the methods discussed above with reference to 30B. The location of the requested data obtained by first accessing the pointer data file which then points to the location of the requested encrypted data in the encrypted data file. This technique may be especially useful in the situation where a legacy database file was used to create the pointer data file. In that case, existing database management software would be used to locate the requested data in the pointer data file which then points to the location of the actual encrypted data.

Turning now to FIG. 34C, the decryption method may further include the steps of providing an encryption key data file (S25) and associating a user with each encryption key (S26). The encryption key data file contains the encryption keys (for symmetric key algorithms) and/or decryption keys (for asymmetric-key algorithms) used to decrypt the encrypted data in the encrypted data file. Preferably, the encryption key data file contains an encryption/decryption key for each field of the encrypted data file. The user may be an individual, hardware unit, or software module. By associating specific users to specific keys, authorization to decrypt data may be customized for each user.

Turning now to FIG. 34D, the decryption method may further include the steps of receiving a login request from a user (S27) and allowing the user to perform the decrypting and displaying steps for each field of encrypted data to which they have an associated encryption key (S28). More specifically, the encryption/decryption keys associated to a user may be stored in a user profile that is accessed when a user logs on to the system. As such, the encryption/decryption keys associated with a user are transparent to the user. In addition, the associations may be controlled by an administrator. Even if a third party obtained the login password of a user having associated encryption/decryption keys, that third party would only have access to data that the user had. In addition, if combined with the techniques described above with reference to FIG. 34A, the third party would not have access to any plaintext data stored in permanent memory since the decrypted data is only temporarily stored in memory and deleted once the requested task was completed (e.g., display of the data).

Process Sharing

In addition to the methods and techniques for encrypting and decrypting data described above, the invention also provides methods and techniques for sharing processes in a distributed computer system, such as the system shown in FIG. 28. These process sharing techniques may be utilized in conjunction with the encryption and data encryption techniques or may be utilized independently.

Based upon a resource and time equation, when a server reaches a certain threshold for a period of time (set by the user), the machine, if it has processes that it is in control of, the processes will then be transferred to another server in the system that is not over its preset threshold and time limit. This threshold and time can be different for all servers in the cluster. When the original server that had control of the process comes within tolerance of the set parameters, the process that was transferred may be moved back to the server that was in charge of that process.

When a machine is offline and was holding processes, the other servers that are alive in the cluster will find that the server has gone offline and then move its processes that it was controlling to a live server. When the server then comes back online the process will be restored to that machine.

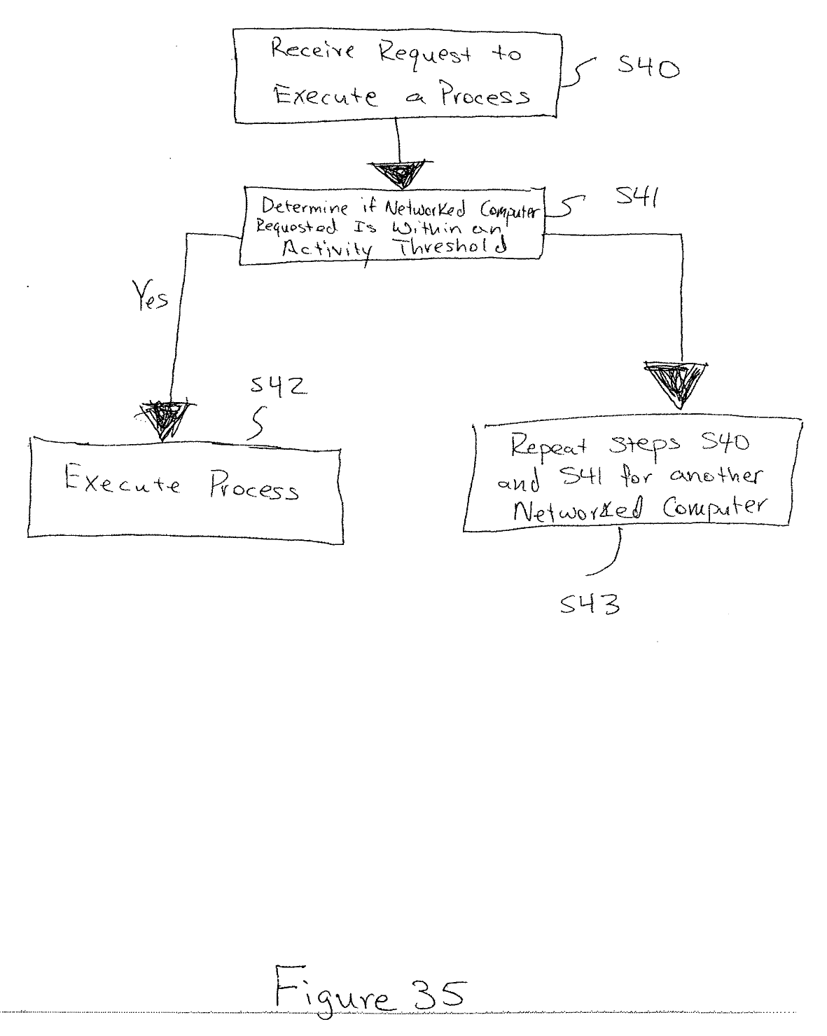

FIG. 35 shows a flowchart of a process sharing method according to one embodiment of the invention. The method is for sharing processes among two or more networked computers and/or electronic devices. The computers and electronic devices may be networked together using any means including wireless connections, LAN connections, and Internet/WAN connections (see FIG. 28).

In step S40, a request to execute a process is received. This request may be received by the device that is to execute the process (e.g., server 1 in FIG. 28). Preferably, the request is received by a device other than the executing device (e.g., requesting device 3 in FIG. 28) that is to send process instructions to the requesting device.

In step S41, it is determined if the networked computer that was requested to execute the process is within a predetermined activity threshold. The activity threshold may be any characteristic of the system of networked computers and requesting devices that may affect the performance of the process.

The predetermined activity threshold may be at least partially based on expected network delays. For example, requesting device 3 may utilize any conventional techniques to determine likely and/or potential delays in sending process instructions and/or data to server 1 to execute a process. For example, the requesting device may ping the server.

The predetermined activity threshold may also be at least partially based on a time to reply to the predetermined activity threshold determination, a time to send the process request to the networked computer, and/or a time to execute the process. The predetermined activity threshold may also be at least partially based on an amount of data needed to send instructions for executing the process, and/or a current load of the networked computer.

The process for sending a process request to a networked computer may include a comparison between the activity of the network and/or the receiving computer (e.g., the activity may include total amount of data to be sent, the receiving computers current CPU usage, and the echo time from a ping to the receiving computer) to a user defined threshold. For example, the expected CPU usage of the receiving computer may be calculated from the computer's current usage and the amount of data to be sent. This expected value would then be compared to a predetermined CPU usage threshold established by the user. As another example, a current echo time from a ping may be compared to a predetermined echo time threshold established by the user. If the echo time of the ping is to long, the process is not sent to that computer.

The time taken and/or needed to execute a process may be another factor taken into consideration. As one example, the time to execute a process is not calculated before the process begins, but instead calculated as the process is being executed. If the process is taking to long to finish (or using too much CPU usage) it may be shared with another networked computer. The following user defined thresholds may be used to determine the time to execute a process: the total CPU usage, the CPU usage for a single process, and the length of time the processes maintain the usage levels. Thresholds may be established in a setup program for maximum usage tolerance and the amount of time the maximums can be sustained. These thresholds are setup for the total of the processes as well as each individual process. For example, a server may have thresholds of 80% total usage for a length time<5 min while an individual process or event may only use 7% for a length of time<1 min. Any time any of these thresholds are exceeded the processes may be passed to the next computer.

In step S42, the process is executed by the requested networked computer if it is determined to be within the predetermined activity threshold. In step S43, if the requested networked computer is not within the predetermined activity threshold, steps S40-41 are repeated for another of the two or more networked computers. This process continues until a networked computer that is within the activity threshold is found.

Redundancy

The invention also provides methods and techniques for live data redundancy in a distributed computer system, such as the system shown in FIG. 28. These redundancy techniques may be utilized in conjunction with the encryption and data encryption techniques or may be utilized independently. In addition, the process sharing and redundancy techniques may also be used together, with or without the encryption and decryption techniques.

When an update to a file or database is made from any server it will automatically be sent to the other servers that are in the cluster. In the event that a server is offline, the items that have been changed from any server will be sent to a queue. When the server that is offline is available again the queue of information will then be sent to the server and it will be back in sync again. This is a first in, first out process. Meaning the same file can be changed at any time and the last one to save will be the one that will be at the server.

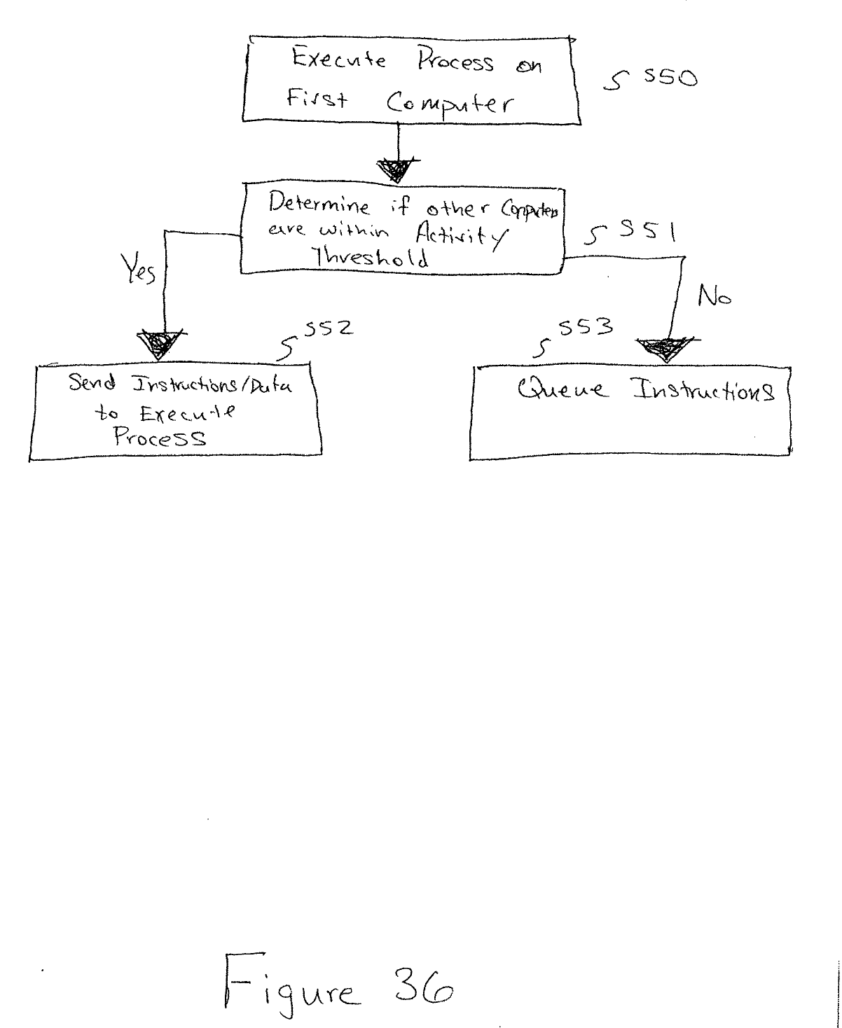

FIG. 36 shows a flowchart of a redundancy method according to one embodiment of the invention. The method is for storing and accessing data between two or more networked computers and/or electronic devices. The computers and electronic devices may be networked together using any means including wireless connections, LAN connections, and Internet/WAN connections (see FIG. 28).

In step S50, a process is executed on a first computer. This process may be any process that amends, adds, or deletes data stored on the first computer. Next, in step S51, it is determined if one or more second computers, connected to the first computer, are within a predetermined activity threshold. The activity threshold may be any characteristic of the system of networked computers and/or requesting devices that may affect the performance of the process.

The predetermined activity threshold may be at least partially based on expected network delays. For example, requesting device 3 or server 1 may utilize any conventional techniques to determine likely and/or potential delays in sending process instructions and/or data to server 1 to execute a process. For example, the requesting device may ping the server.

The predetermined activity threshold may also be at least partially based on a time to reply to the predetermined activity threshold determination, a time to send the process request to the networked computer, and/or a time to execute the process. The predetermined activity threshold may also be at least partially based on an amount of data needed to send instructions for executing the process, and/or a current load of the networked computer.

In step S52, instructions for executing the process executed by the first computer are sent to each of the second computers that are determined to be within the predetermined activity threshold. In step S53, if any of the second group of computers is not within the predetermined activity threshold, the instructions for executing the process are placed in a queue on those computers. The computers that were not within the predetermined thresholds execute the processes stored in the queue when they come back into process. According to one aspect of the invention, if the time a networked computer remains out of tolerance or the time a process remains in the queue is longer than a predetermined length of time, the computer does not execute the processes in the queue. Rather, that computer obtains the entire database contents of another redundant system that is within tolerance and copies that content to its internal databases.

Since all computers in such a redundant system continuously update each other, the data stored on each of the computers may be used by each of the other computers at any time. As such, if one computer is unable to access data stored on its internal data storage devices (e.g., because of catastrophic failure or removal), that computer may access data stored on another computer to carry out any process.

Physical Access Control Example

The following figures and description represent one example implementation of various aspects of the encryption, decryption, process sharing, and redundancy features of the invention. In particular, the following example relates to an entry control system. Such systems are typically used to control and/or prevent physical access to selected areas of buildings and complexes. However, the modules and sub-modules described below may be altered to work with any system where secure storage of live data is desired.

The entry control system described below, which incorporates various aspects of the invention, may incorporate a plurality of redundant servers, each server running software which performs various methods and techniques of the invention. The workload between any or all servers may be shared through the process sharing techniques described above. In addition, the entry control system provides database security through the use of various aspects of the encryption and decryption techniques described above. Individual database fields are encrypted with private and public keys (e.g., a FIPS 140-2 based encryption algorithm). In addition, the following entry control system adds an additional layer of encryption to packets of data sent between devices (e.g., server to server).

The following figures show the system, software modules, software functions, and steps to implement this entry control system example. The software modules and functions may be implemented through a specifically designed software application and/or platform, or may be integrated into existing operating systems and database management software applications (e.g., Microsoft, Oracle, Cisco, etc.).

FIG. 1 is a block diagram of an entry control system in its normal operating environment. The entry control system may include one or more servers 101 connected to each other through network communications 139 (see, e.g., FIG. 28). Each server 101 operates software 102 to carry out the functions of the system. Software 102 includes a Data Security module 103, Check Tolerances module 104, Network Line Handler module 106, and a Post Events module 108. In addition, software 102 utilizes various databases to carry out its functions. The modules and databases will be discussed in more detail below.

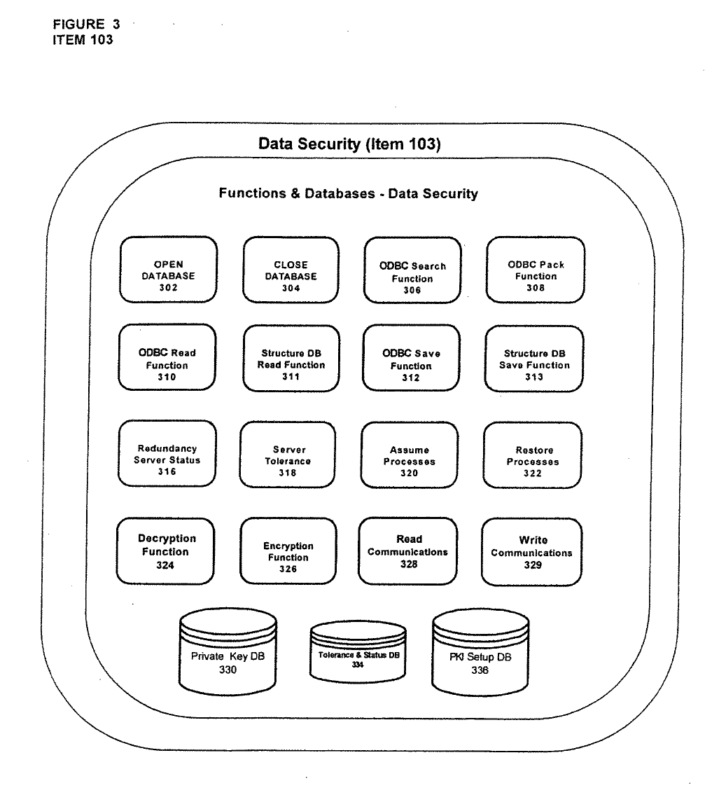

Data Security module 103 utilizes various aspects of the encryption, decryption, process sharing, and redundancy techniques described above, sometimes in conjunction with the other software modules, to provide security for confidential data from being stolen and understood by an intruder. In part, this is accomplished by encrypting and saving individual database fields with a private key rather that the whole database. Data Security module 103 allows users of its libraries to decrypt an individual record and/or field rather then decrypting the entire file. Data Security module 103 is applicable for use with both structural databases and relational databases (e.g., an ODBC-based database). For example, when an ODBC compliant file is used, the encrypted data is stored in the ODBC Extended database 114. Data Security module 103 also provides for process sharing and control by sharing the workloads of servers 101. In addition, Data Security module 103 provides for live redundancy on multiple servers. The functions of Data Security module 103 will be discussed in more detail in the description of FIG. 3.

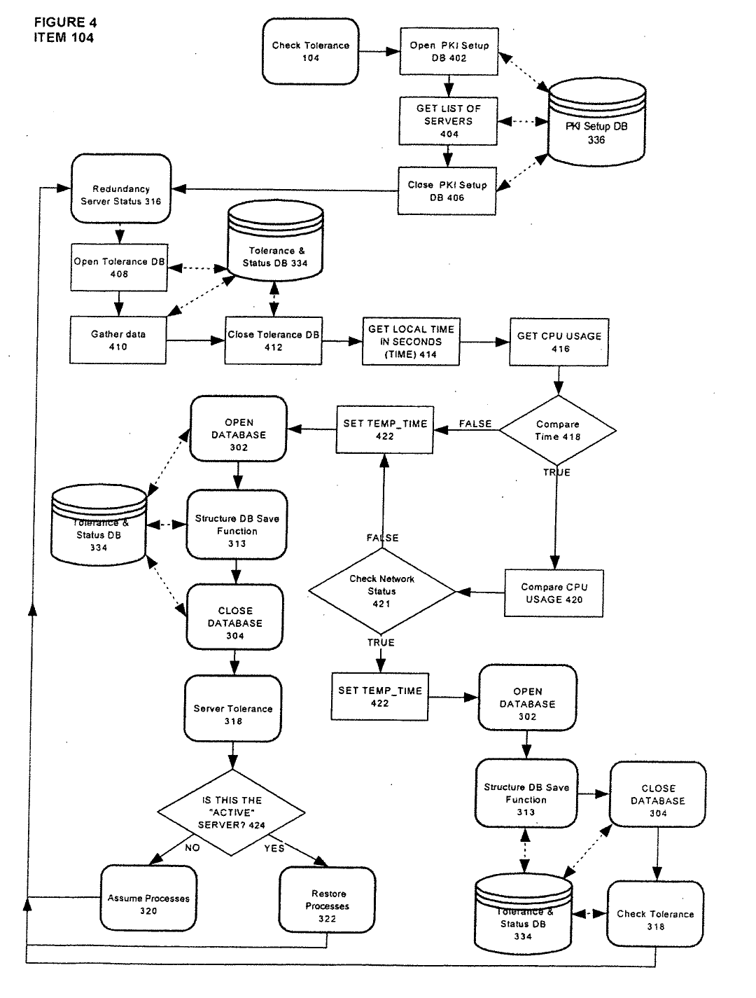

Check Tolerances 104 module calculates the tolerance levels (i.e., predetermined activity thresholds) for all servers 101 in the network. Data Security module 103 functions are integrated with the Check Tolerances module 104. In addition, Check Tolerances module 104 “calls” the Data Security module 103 functions as part of its program. Check Tolerances module 104 also uses the Data Security module 103 functions to determine if servers 101 on the network are “Alive” (able to communicate with another co-operating device), and are within the tolerances set in the tolerance database for CPU usage. If the “Active” Server is out of tolerance, Check Tolerances module 104 uses the Data Security module 103 functions to redirect the processes from one server to another. When the originally-selected server comes back into tolerance, Check Tolerances module 104 uses the Data Security module 103 functions to restore the workload back to that server. Each time a file is transferred to another co-operating device in this function, Data Security module 103 uses Public and/or Private Key Databases to encrypt and/or decrypt the databases required for processing, communicating and enabling process sharing. When files are transferred to a co-operating device (servers 101 or processor panels 140), the file is double encrypted as the original file was encrypted with a public and private key and the transferred file or record is also encrypted with another private key. The functions of Check Tolerances module 104 will be discussed in more detail in the description of FIG. 4.

Data Security module 103 functions are also integrated with the Network Line Handler module 106. Network Line Handler module 106 “calls” Data Security module 103 functions as part of its functions. These processes include encrypting and decrypting databases for processing, communications and enabling process sharing. Network Line Handler module 106 sends and receives data between servers 101 and processor panels 140. When files are transferred to a co-operating device (servers 101 or processor panels 104) the file is double encrypted since the original file was encrypted with a public and private key and the transferred file or record is also encrypted with another private key. In addition, Network Line Handler module 106 decrypts sent and received data, gathers information (located in various databases) required to process an event, formats data for the co-operating devices, encrypts data, and determines which server to forward data to for processing.

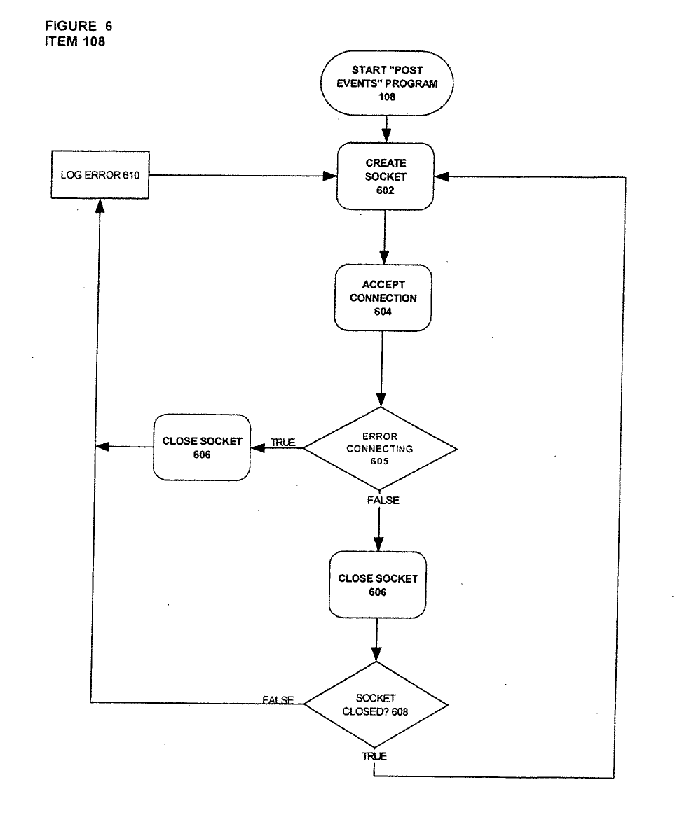

Data Security module 103 functions are also integrated with Post Events module 108. Post Events module 108 “calls” Data Security module 103 functions as part of its program. Post Events module 108 uses the Data Security module 103 functions to process the events and manual requests from the user to communicate between the co-operating devices (servers 101 and processor panels 104). The functions of Post Events module 108 will be described further in the description of FIG. 6.

Structured databases 110, including route DB 120, monitor point DB 124, reader DB 122, ODBC Extended database 114, and tolerance DB (not shown), are used by Data Security module 103 functions. Route DB 120 contains a list of devices where events can be sent for processing. The contents of route DB 120 may be encrypted. Reader DB 122 contains information needed to process an Access Control Event (i.e., a user requesting to enter a certain location). The contents of reader DB 122 may be encrypted. Monitor point DB 124 contains information needed to process an event at the monitor (alarm) point). The contents of monitor point DB 124 may be encrypted.

Data Security module 103 enables the user to encrypt each data record within these structured databases. Data Security module 103 encrypts the individual records of theses structured databases, allowing only authorized users to view, edit or delete specific records. Depending on the password level of the user, the structured databases may display or not display the individual database records. Structured databases are stored on a hard disk drive (HDD) of server 101 as a record within a table and may be encrypted. The records are decrypted for viewing, editing and when the modules or functions use information within the database. This protects information in the file from being useful if copied or “hacked into” from outside sources.

Data Security module 103 functions are used to create and use ODBC-compliant databases such as ODBC databases 112. Data Security module 103 encrypts and decrypts database fields from an ODBC-compliant database (such as ODBC database 112) and stores the data as encrypted data in ODBC extended database 114 (a structured database). When the field is decrypted, it is restored to a field in ODBC database 112. The encryption/decryption is accomplished with the use of a configuration found in the PKI Setup DB 336 (see FIG. 3). The PKI Setup DB defines which fields of the ODBC-compliant database are to be encrypted. Data Security module 103 encrypts the specified fields, and saves the field data in the Extended ODBC database 114. In the field of the ODBC-compliant database where the information was originally stored, a link (or tag) is stored directing the software where to find the encrypted data. Dependent on the password level of the user when a request to view edit or use a data field is made, Data Security module 103 will get the link found in the ODBC database 112 and the linked data in the Extended ODBC database 114. The data can then be displayed, edited or used by the software. If the user does not have the authorization to view and/or edit the data the words “Encrypted” or an appropriate symbol (e.g., “****”) will be displayed in the field where the information should be located.

Data Security module 103 functions are integrated with other software modules and functions and are used to create and use employee DB 126. Employee DB 126 contains confidential employee information. The contents of employee DB 126 may be encrypted. Data Security module 103 enables the user to encrypt data fields within each record of this database, though encryption of this database is not required. Encryption is accomplished by configuration found in the PKI Setup DB 336 (FIG. 3), a public key assigned by the US Government and a private key defined by the user in private key DB 330 (see FIG. 3). The Employee Database 126 is an ODBC-compliant Database. Data Security module 103 encrypts the specified fields of the Employee Database, allowing only authorized users to view edit or delete specific fields and records. Dependent on the password level of the user the employee database may display or not display the individual database fields. Employee Database 126 (or any ODBC compliant database) is stored on the HDD as a record within a table. It is encrypted and decrypted only when viewing, editing or when a software program uses information within the database. This protects information in file from being useful if copied or “hacked into” from outside sources.

Processor panels 140 are hardware panels that control devices used to allow and/or prevent entry (e.g., opening a lock, allowing the selection of a floor in an elevator, opening a gate, etc.). The processor panels may utilize some or all of the software functions found in servers 101. Processor panels 140 gather information regarding events and alarms that are processed by the software 102. This information is communicated to co-operating devices, including software 102, using Data Security module 103. The data is encrypted with a public key assigned by the US Government and a “private key” (Private Key DB 330) when it is sent to the co-operating device through the network. Data Security module 103 is integrated within the software running on the processor panels.

FIG. 3 is a functional block diagram of Data Security module 103 according to one embodiment of the invention. Data security module 103 includes the following sub-modules and databases:

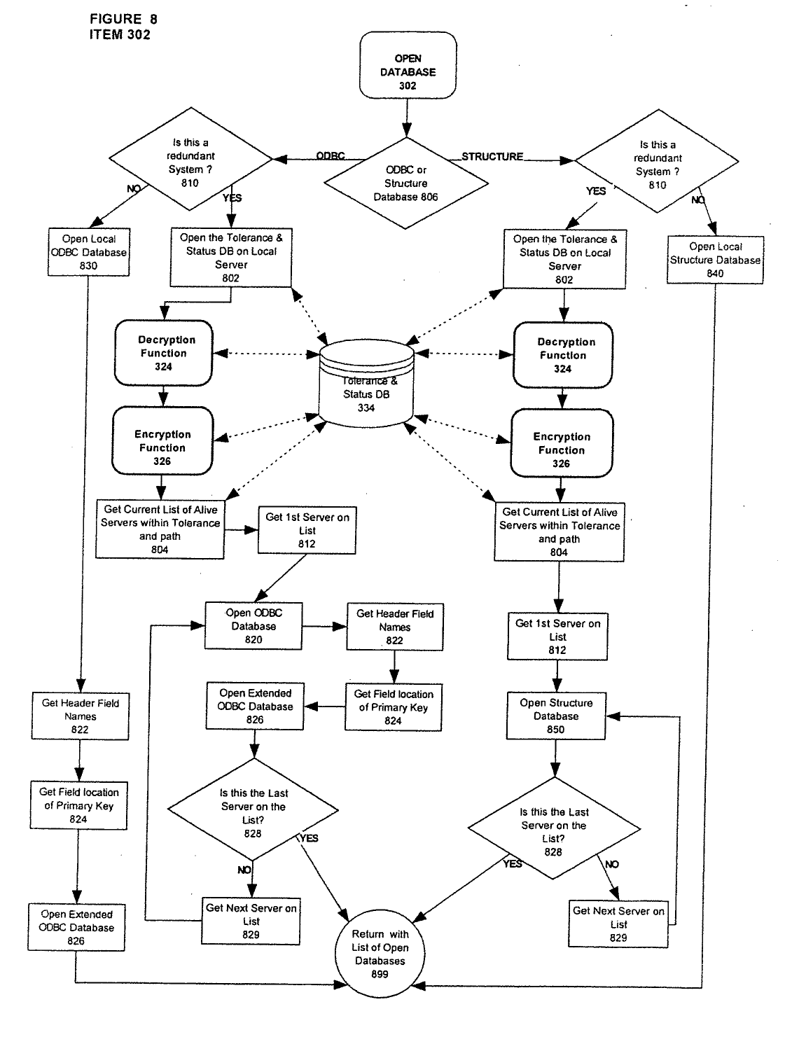

Open Database sub-module 302 is used to open the databases on each server (in a redundant system). Open Database sub-module 302 opens the ODBC & Structure databases on any or all servers that are alive (i.e., within tolerance/predetermined activity threshold). For ODBC Databases, Open Database sub-module 302 gets the Field Name (see FIG. 8, elements 822, 832) and the primary key (see FIG. 8, element 824). For ODBC Databases, the primary key for records in ODBC Databases 112 point to records in associated Extended ODBC Databases where encrypted data is stored. Open Database sub-module 302 then repeats the steps to open the databases on all the servers on the list. Open Database then returns with a list of the open databases. The operation of Open Database sub-module 302 will be discussed in more detail in the description of FIG. 8.

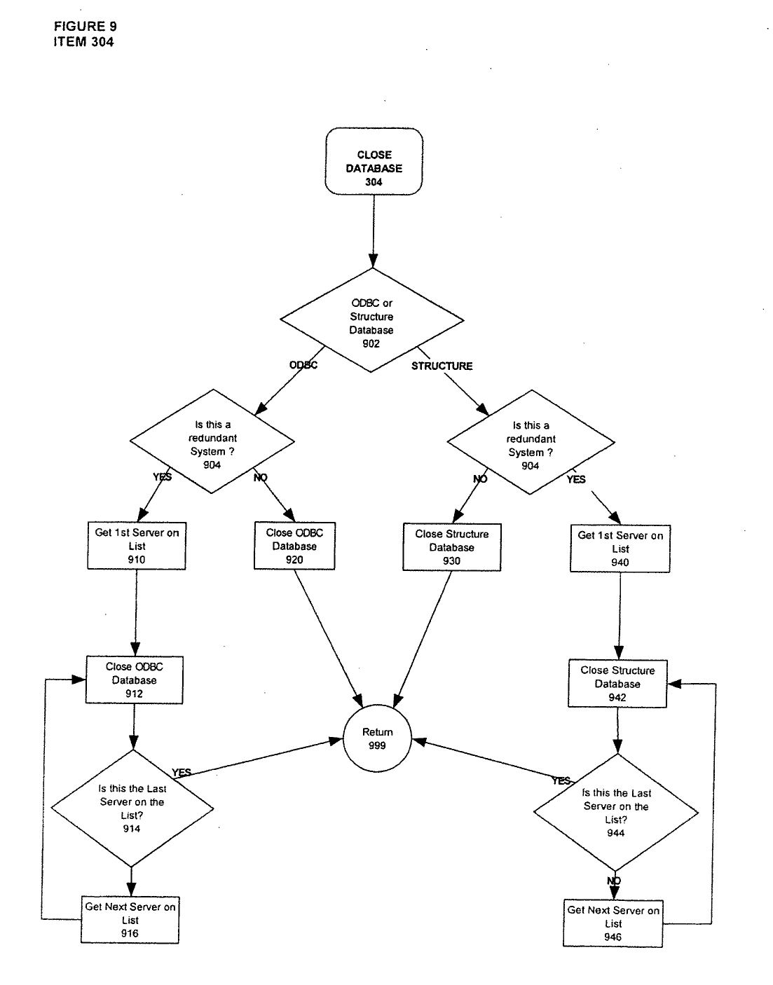

Close Database sub-module 304 closes the ODBC & Structure databases on any or all servers that are open and ‘alive’ (see FIG. 9, elements 912, 920, 930, 942). The operation of Close Database sub-module 304 will be discussed in more detail in the description of FIG. 9.

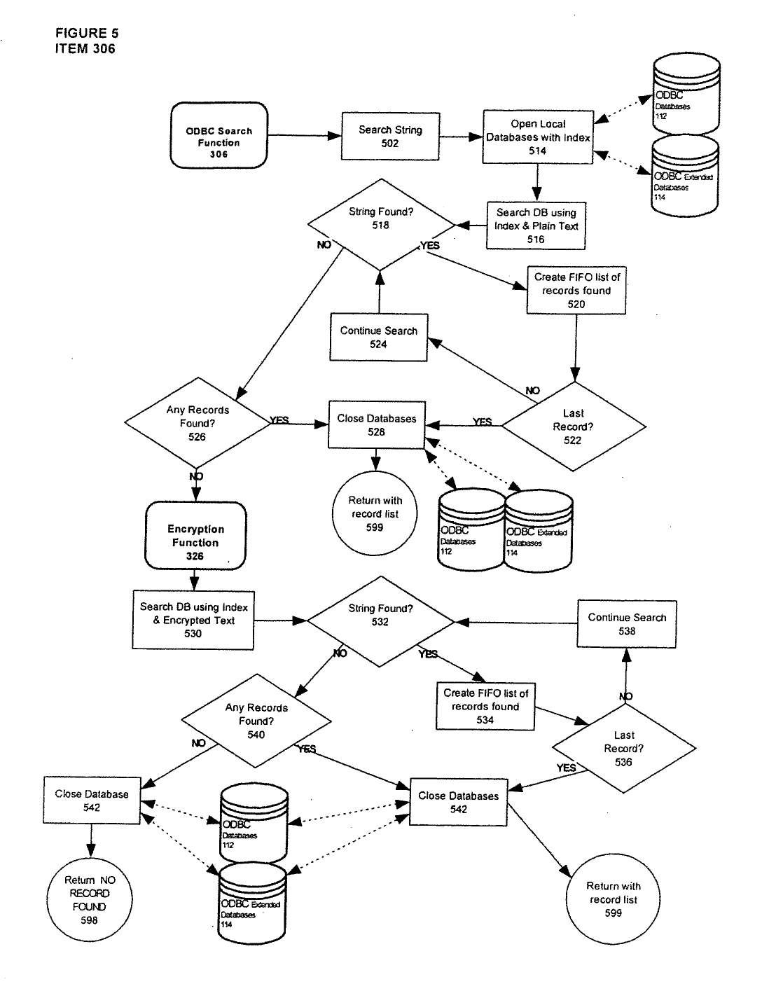

ODBC Search Function sub-module 306 allows the user to search encrypted ODBC & Structure databases on any or all servers that are open and alive. The operation of ODBC Search sub-module 306 will be discussed in more detail in the description of FIG. 5.

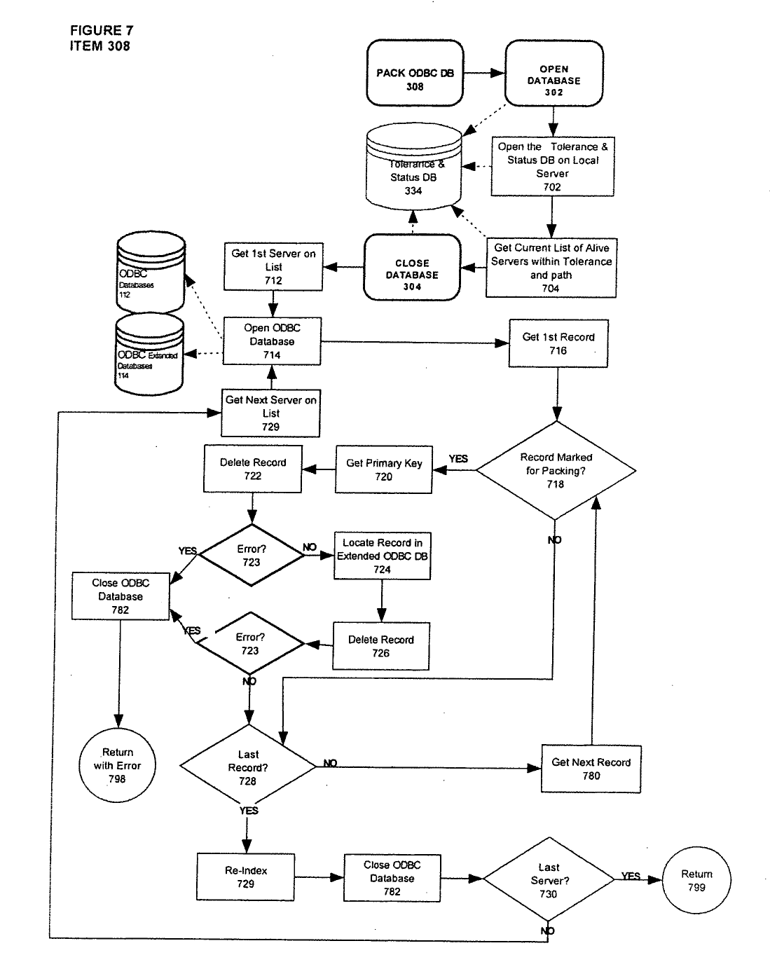

ODBC Pack Function sub-module 308 removes records marked for deletion and “packs” ODBC encrypted and decrypted files on any or all servers that are open and alive. The operation of ODBC Pack Function sub-module 308 will be discussed in more detail in the description of FIG. 7.

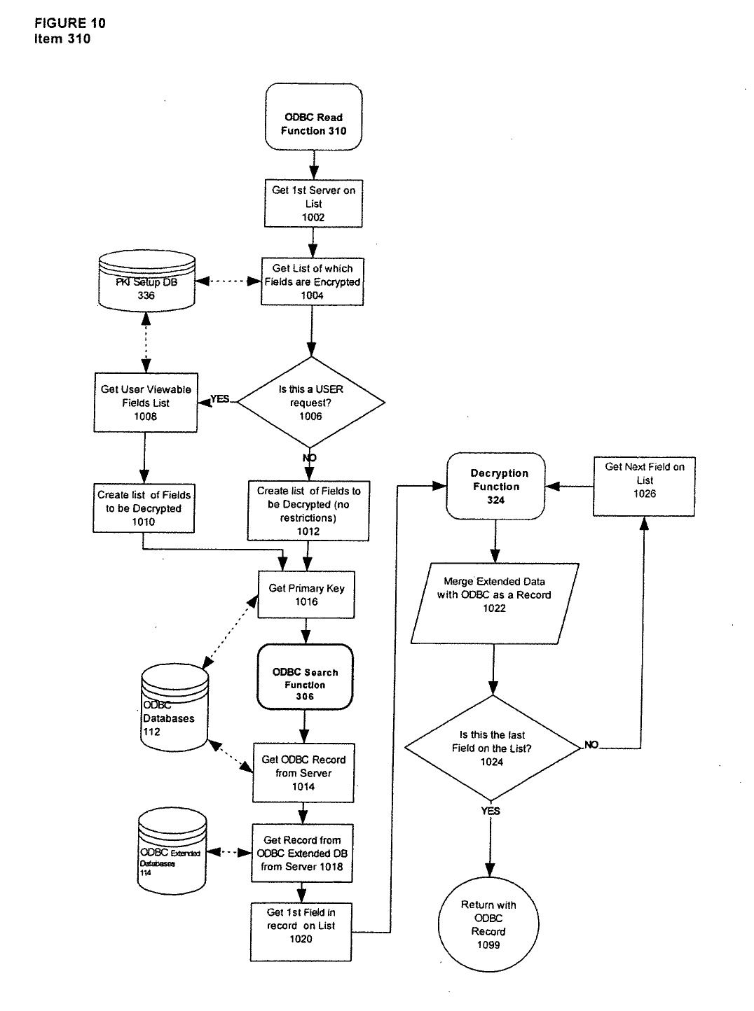

ODBC Read Function sub-module 310 reads data stored on ODBC databases. ODBC Read Function sub-module 310 gets the list of fields that are encrypted from the PKI Setup DB 336. ODBC Read Function sub-module 310 determines if there is a user request. If yes, ODBC Read Function sub-module 310 gets the list of permissions for the user from the PKI Setup DB 336. ODBC Read Function sub-module 310 creates list of fields to be decrypted. If the read request was not from a user, ODBC Read Function sub-module 310 creates a list of fields to be decrypted with no restrictions. ODBC Read Function sub-module 310 searches the database to get the appropriate field to be read. ODBC Read Function sub-module 310 gets from the record the primary key and the associated ODBC Extended DB and field from the server. ODBC Read Function sub-module 310 gets each field to be decrypted, decrypts it (see Decryption Function sub-module 324) and merges it with the ODBC DB until all required fields are decrypted. ODBC Read Function sub-module 310 returns with the ODBC record. The operation of ODBC Read Function sub-module 310 will be discussed in more detail in the description of FIG. 10.

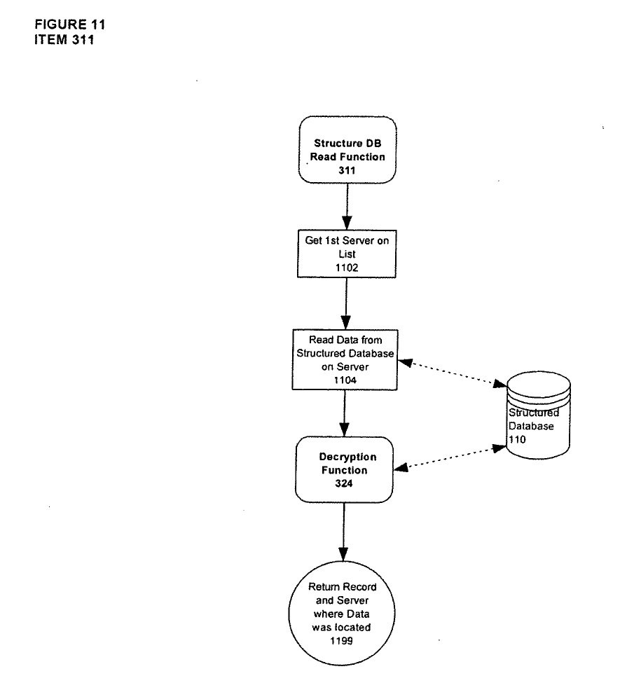

Structure DB Read Function sub-module 311 reads and decrypts data from structured databases, such as Structured Databases 110. Structure DB Read Function sub-module 311 first determines if the system is redundant. If the system is redundant, Structure DB Read Function sub-module 311 finds the first available server within usage tolerance from the Tolerance & Status DB 334. Structure DB Read Function sub-module 311 then reads the data from the server stored on a structured database 110. Structure DB Read Function sub-module 311 also utilizes Decryption Function sub-module 324 to decrypt the data. The operation of Structure DB Read Function sub-module 311 will be discussed in more detail in the description of FIG. 11.

ODBC Save Function sub-module 312 saves and encrypts data in ODBC databases. ODBC Save Function sub-module 312 gets a list of fields to be encrypted from the PKI Setup DB 336. ODBC Save Function sub-module 312 encrypts the required fields stuffing the encrypted data in an ODBC Extended DB 114. ODBC Save Function sub-module 312 tags the field in the ODBC DB 112 where the data came from with a link to the ODBC Extended DB 114. ODBC Save Function sub-module 312 also determines if the system is redundant. If not, ODBC Save Function sub-module 312 writes each field of each record of ODBC DB 112 on the current server. ODBC Save Function sub-module 312 also creates the primary key for the ODBC Extended DB 114. The primary key points a record and/or field in the relational ODBC Database 112 to a record and/or field in structured ODBC Extended Database 114 in which the encrypted data is stored. ODBC Save Function sub-module 312 also writes each field of each record to the ODBC Extended DB 114 on the current server.

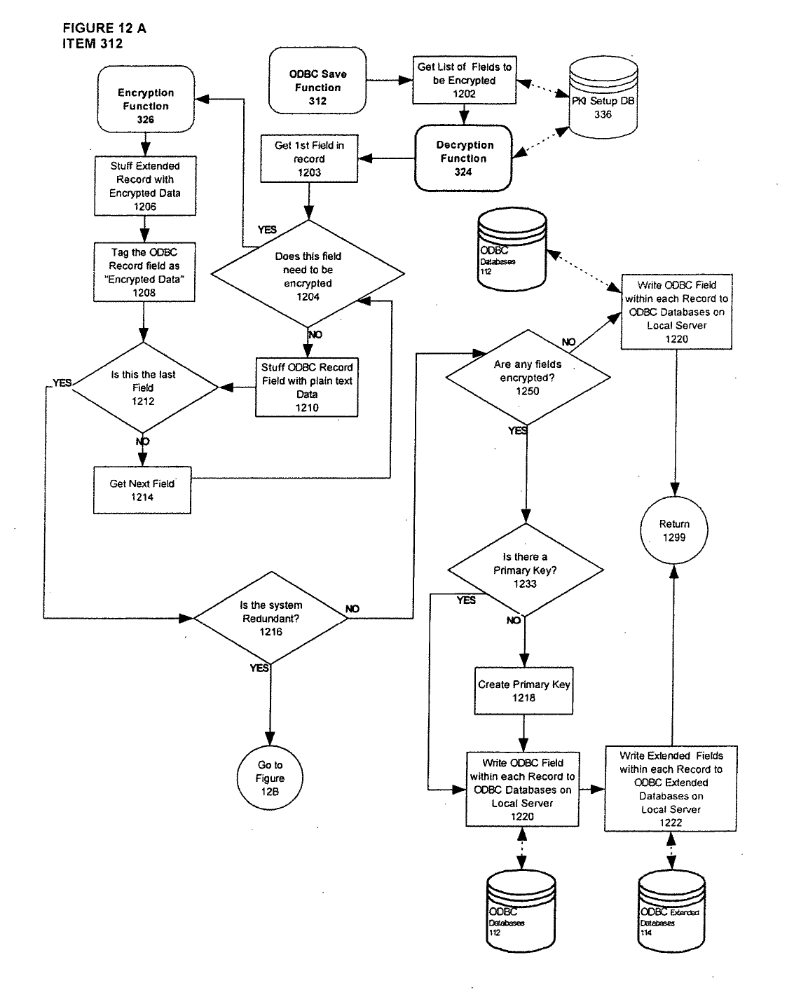

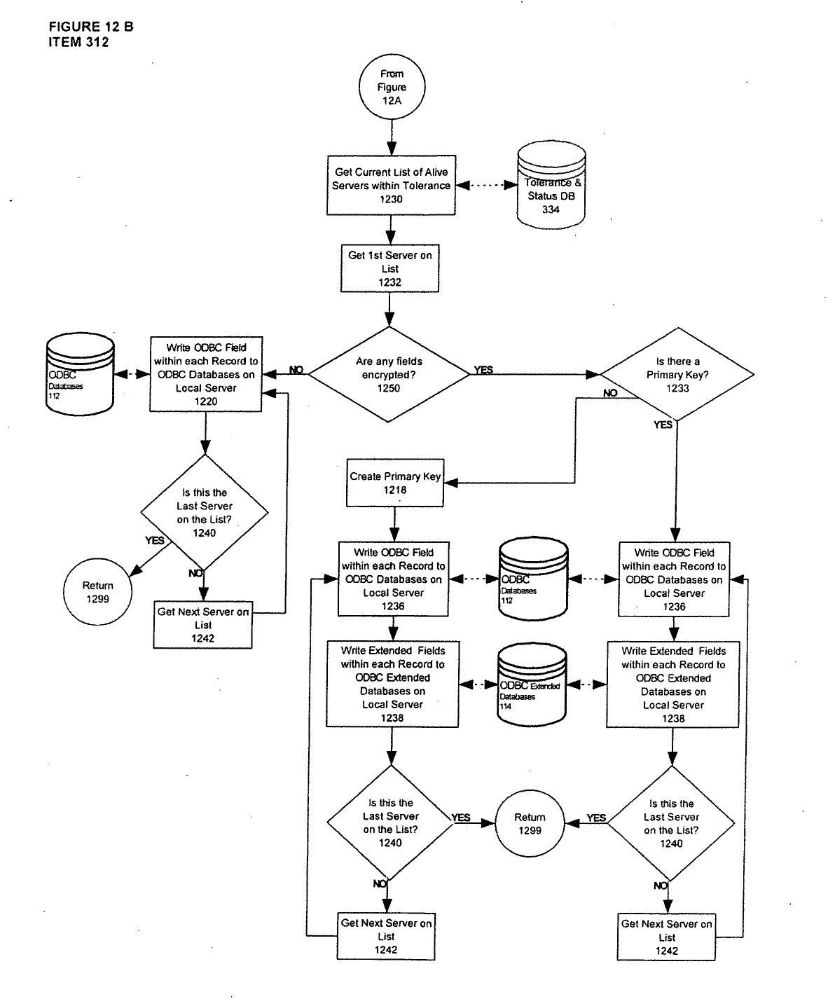

If the system is redundant, ODBC Save Function sub-module 312 gets a list of all servers from the Tolerance & Status DB 334. ODBC Save Function sub-module 312 writes each field of each record of ODBC DB 112 on each server. ODBC Save Function sub-module 312 creates the primary key for the ODBC Extended DB 114. ODBC Save Function sub-module 312 writes each field of each record to the ODBC Extended DB 114 on each server. The operation of ODBC Save Function sub-module 312 will be discussed in more detail in the description of FIG. 12.

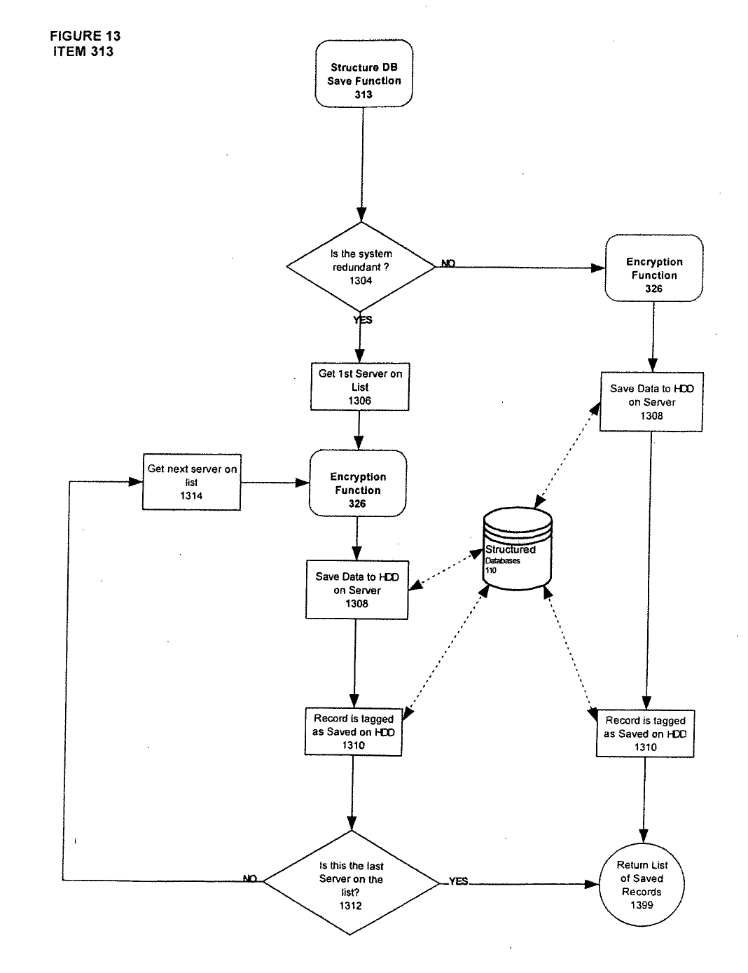

Structure DB Save Function sub-module 313 saves and encrypts data in structured databases. It may be used to save databases across a network or as a standalone database. Structure DB Save Function sub-module 313 also encrypts data in a structure databases 110. The operation of Structure DB Save Function sub-module 313 will be discussed in more detail in the description of FIG. 13.

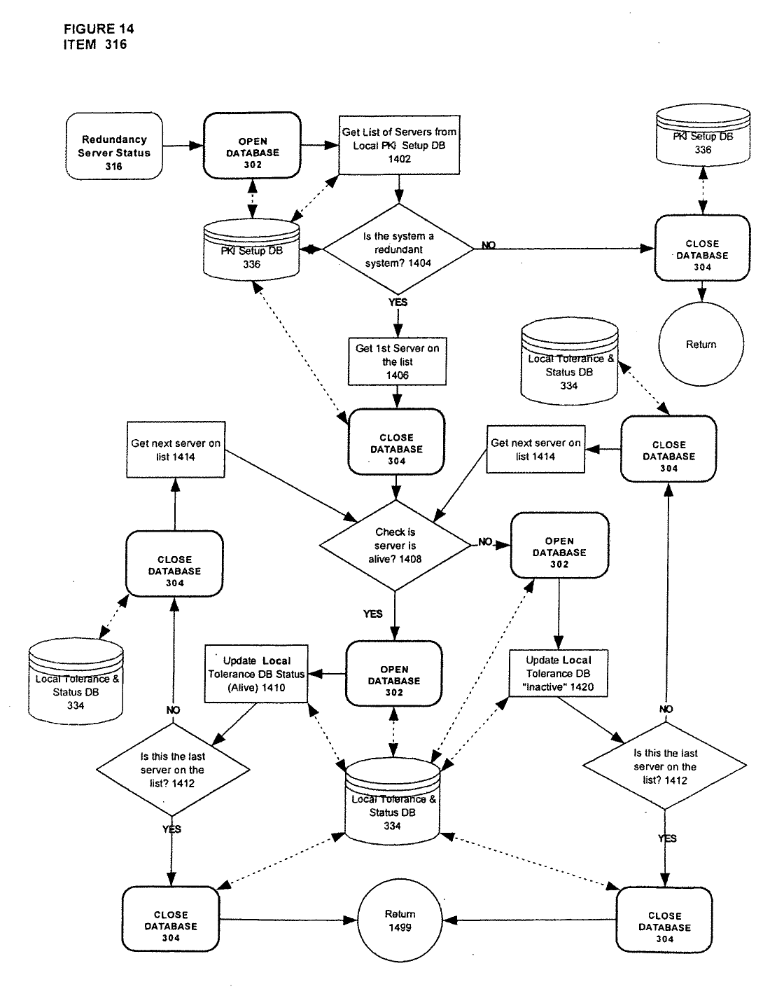

Redundancy Server Status sub-module 316 checks the status of the servers to determine if they are “alive” Or “Inactive.” Redundancy Server Status is also part of the continuous loop of Check Tolerance module 104. The operation of Redundancy Server Status sub-module 316 will be discussed in more detail in the description of FIG. 14

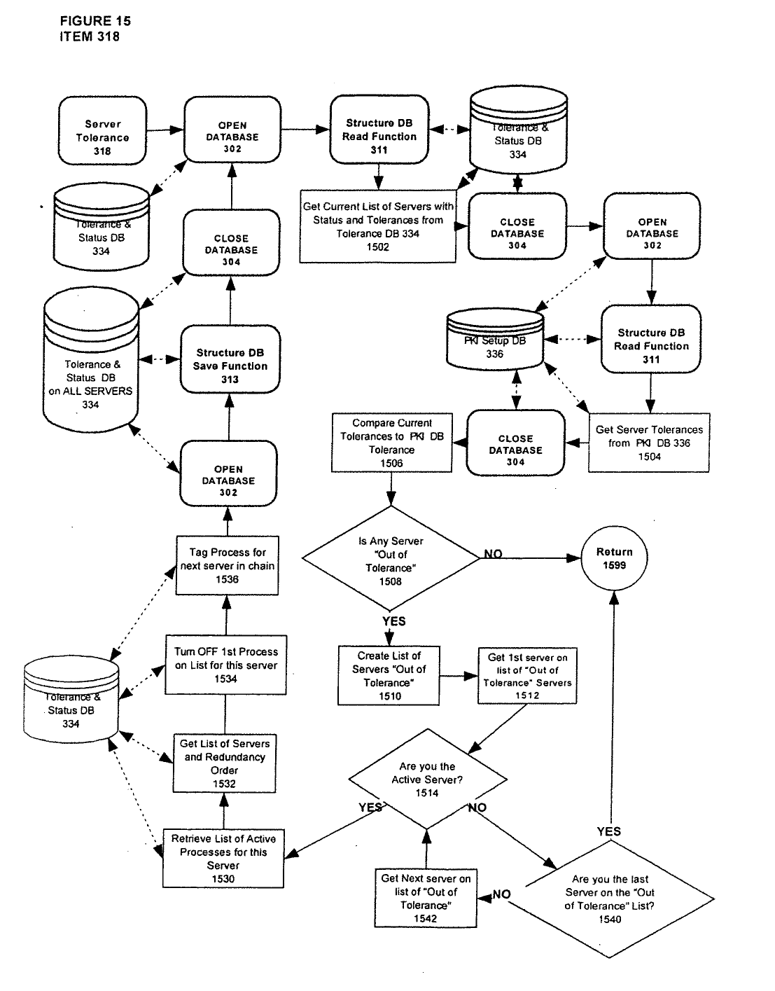

Server Tolerance sub-module 318 checks the status of the servers to determine if the CPU usage of each server is out of tolerance when compared to the tolerances set in the PKI Setup DB 334. The operation of Server Tolerance sub-module 318 will be discussed in more detail in the description of FIG. 15.

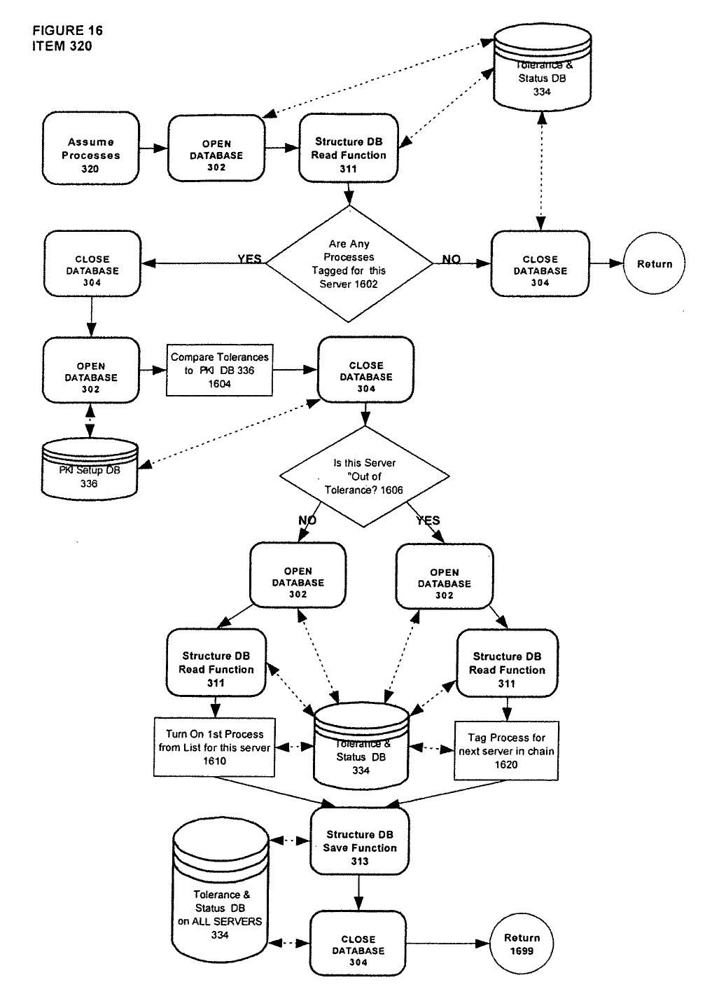

Assume Processes sub-module 320 reassigns process from a server that is out of tolerance to one that is within tolerance. Assume Processes sub-module 320 enables Data Security module 103 to share the workload between servers in a network. The operation of Assume Processes sub-module 320 will be discussed in more detail in the description of FIG. 16.

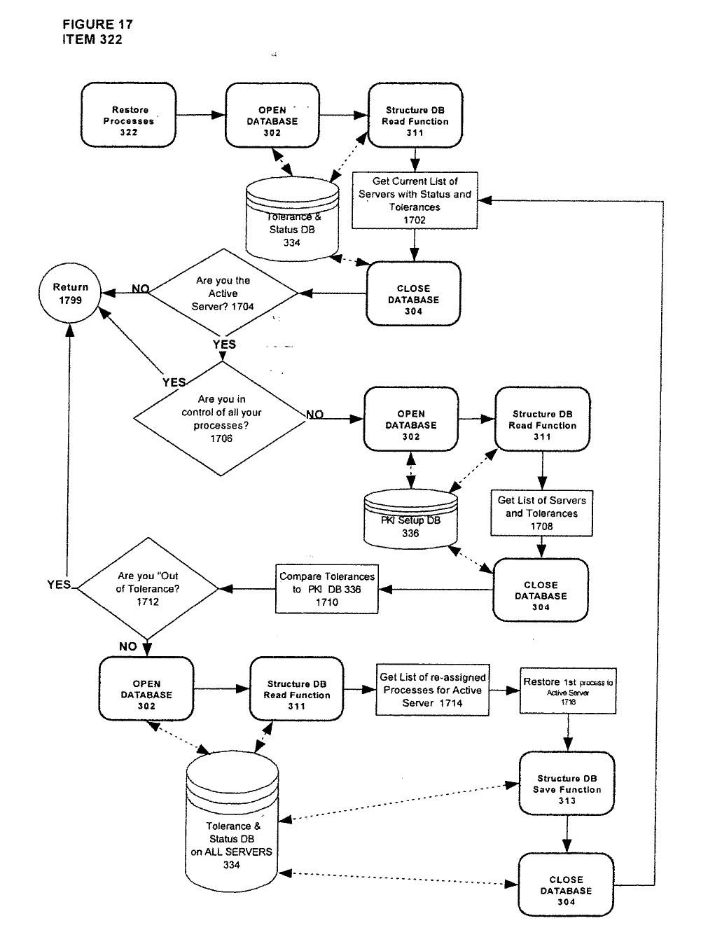

Restore Processes sub-module 322 reassigns processes to the original Active server when its CPU usage is back within tolerance levels established in the PKI Setup DB 336. the operation of Restore Processes sub-module 322 will be discussed in more detail in the description of FIG. 17.

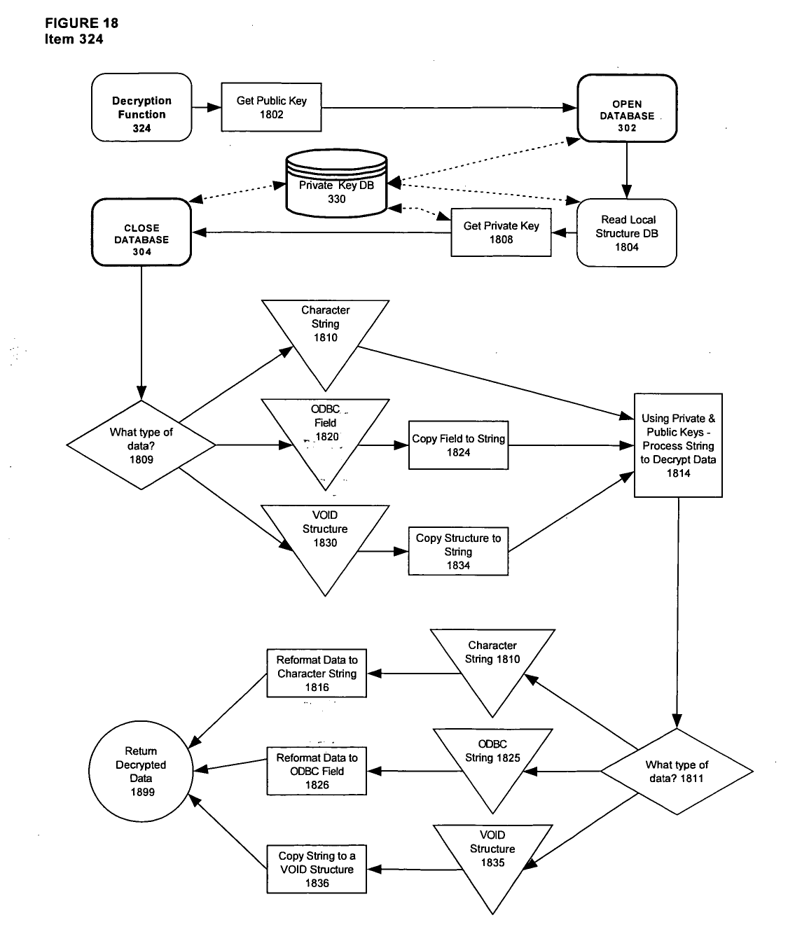

Decryption Function sub-module 324 decrypts database files, fields and records. Decryption Function sub-module may be configured to only decrypt data for authorized users. The decrypted data is stored in temporary memory and deleted when no longer needed. The database fields, records and files remain encrypted on the HDD. This keeps unauthorized individuals from taking information off the HDD and being able to understand the data. Decryption Function sub-module 324 can configure multiple keys within the same record or file. The operation of Decryption Function sub-module 324 will be discussed in more detail in the description of FIG. 18.

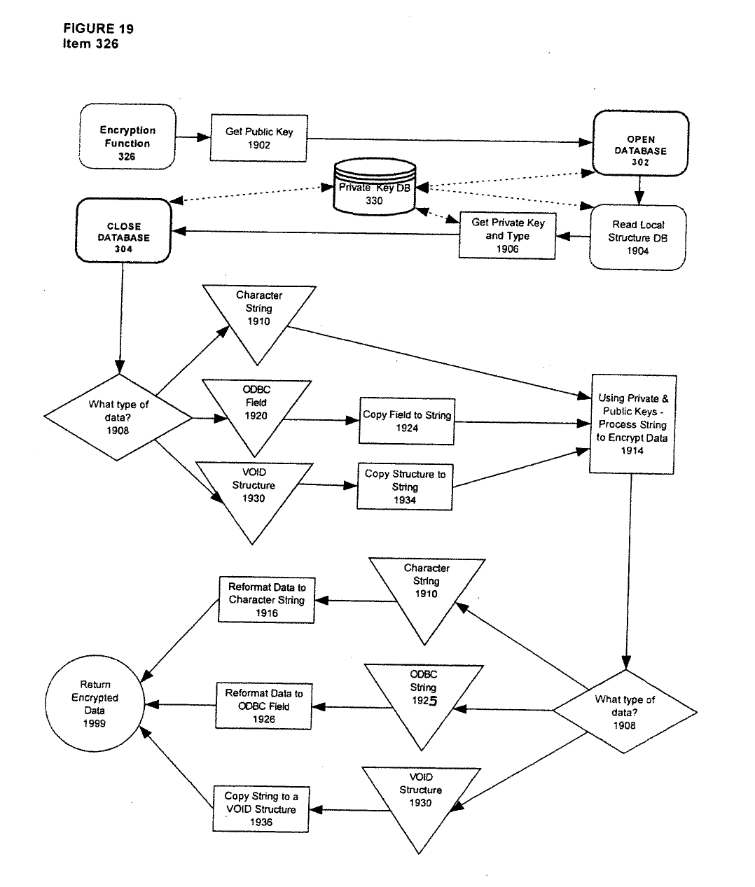

Encryption Function sub-module 326 encrypts database files, fields and records. Encryption Function sub-module 326 can configure multiple keys within the same record or file. The operation of Encryption Function sub-module 326 will be discussed in more detail in the description of FIG. 19.

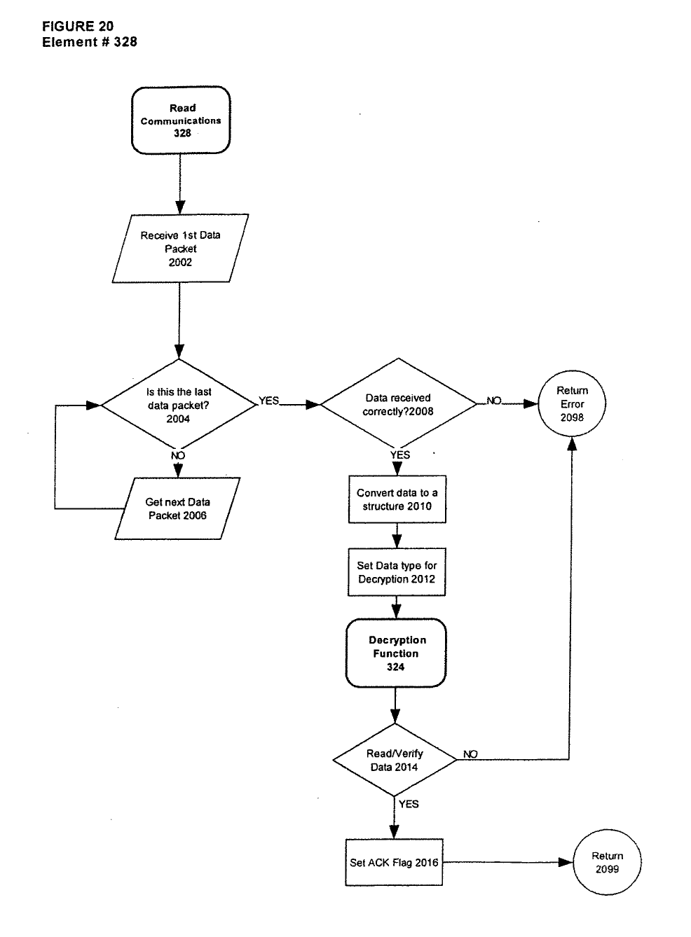

Read Communications sub-module 328 allows records to be read across a communications path. Read Communication sub-module 328 decrypts database fields and records before being read using the public and private keys. Read Communications sub-module 328 can be used with multiple keys within the same record or file. The operation of Read Communication sub-module 328 will be discussed in more detail in the description of FIG. 20.

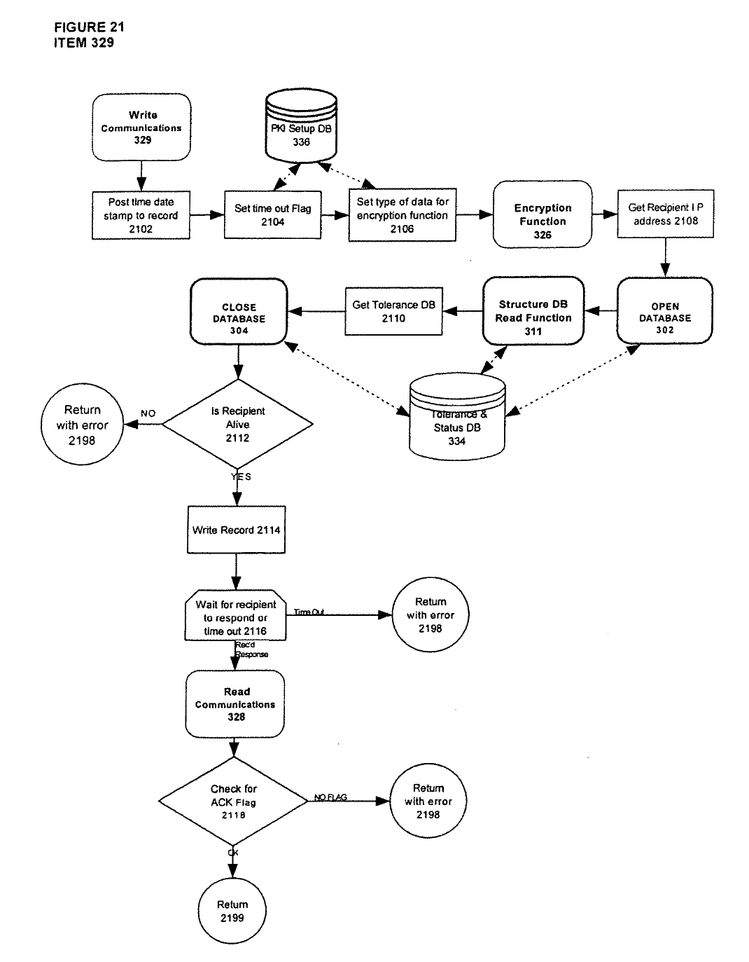

Write Communications sub-module 329 writes database files, fields and records to a file across a communication path. Write Communications sub-module 329 checks the Tolerance & Status DB 334 to determine if the recipient co-operating item is alive. Write Communications sub-module 329 encrypts the database fields, records and files with a public and private key, creating a dual encrypted file. The operation of Write Communications sub-module 329 will be discussed in more detail in the description of FIG. 21.

Private Key DB 330 contains the private keys used by Data Security module 103. Private Key DB is created in the setup of the software. Private Key DB 330 is encrypted and the decryption key may be buried in the software rather than in a database so that it is not identifiable.

Tolerance & Status DB 334 is a structured database and contains the tolerance levels and current status of the servers in the network. Tolerance & Status DB 334 is created in the setup of the software and is a structured database. Tolerance & Status DB 334 contains the following fields: active; alive, CPU Server Percentage Process; CPU Server Percentage Wait Time; Switch Wait Time Full control; last CPU Server Percentage; ping Time Out; time; memory; PKI, ID; Server; SPP. The above listed data fields are used to calculate the server tolerances. The definition of each of the data fields is below:

Active—the current server is the primary server (all other servers are not active)

Alive—any server that can communicate

CPU Server Percentage Process—the CPU run time level (for all processes)

CPU Server Percentage Wait Time—the out of tolerance time for the CPU in nano seconds

Switch Wait Time Full control—the CPU run time level (for each process)

last CPU Server Percentage—the out of tolerance time for the last CPU in nano seconds

ping Time Out—how long to wait for response to a ping (an echo)

time—local time in seconds

memory—amount of Random Access Memory

PKI—Public Key Infrastructure identification

ID—Device identification

Server—a single or cluster of CPU's that are designated for a set of tasks

SPP—Standalone Processor Panel (an access control field panel controller PKI Setup DB 336 contains the setup information required to use by Data Security module 103 (servers and paths and list of encrypted fields, etc). PKI Setup DB is created in the setup of the software. PKI Setup DB is encrypted and the decryption key is buried within the software.

FIG. 4 is a flowchart of Check Tolerance module 104 according to one embodiment of the invention. First, in Open PKI Setup DB step 402, PKI Setup DB 336 on the local server (i.e., the server containing the software that is currently running the check tolerances module). In step 404, a list of servers is read from the open PKI Setup DB (336). The list contains the names and/or addresses of servers that are configured in the network and which server is the “Active” server. The active server is the server that has been assigned responsibility of the current process. In step 406, PKI Setup DB 406 on the local server is closed. The open and close functions of steps 402 and 406 may be accomplished using any conventional programming techniques.

Next, Redundancy Server Status sub-module 316 checks the status of the servers to determine if they are “Alive” Or “Inactive.” This information is then saved on Tolerance & Status DB 334 on each server. The operation of Redundancy Server Status sub-module is discussed in more detail in the description of FIG. 14. In step 408, the Tolerance & Status DB 334 is opened on the local server. In step 410, the Tolerance & Status DB 334 is read and data is gathered for the local server. The data that is gathered comes from the following fields in Tolerance & Status DB: “Temp_Time”, “Wait_Time”, and “CPU Usage Setting.” Time—local time in seconds. Temp_Time is the previous time stored in the Tolerance DB. Wait_Time is how long to wait between cycles and is defined in the setup process. CPU Usage Setting is the maximum CPU usage level and is defined in the setup process. In step 412, Tolerance & Status DB 334 is closed on the local server. Again, the open and close functions of steps 408 and 4012 may be accomplished using any conventional programming techniques.

In step 414, the local time in seconds for the CPU (“Time”) is obtained. In step 416, the CPU usage for the local server is obtained.

In step 418, the obtained local time (“Time”) of the local server is compared to the “Temp_Time” plus “Wait_Time” gathered from Tolerance & Status DB 334. If “Time” is greater than “Temp_Time” plus “Wait_Time”, the CPU usage obtained from the local server is compared to the “CPU Usage Setting” gathered from the Tolerance & Status DB 334 in step 420. Then in step 421, the network status is checked against a predetermined speed by pinging the CPU to see if it is in tolerance. This predetermined speed is stored locally on the server in the Tolerance & Status DB 334. If step 421 determines that the network was in status, a new temp_time is set with the currently obtained “Time” value (see step 414) in step 422 and saved in Tolerance & Status DB 334 (on each server in a redundant system) using Open Database sub-module 302, Structure DB Save Function sub-module 313, and Close Database Function sub-module 304. The operations of these sub-modules will be discussed in more detail in the descriptions of FIGS. 8, 13, and 9, respectively. Then, Server Tolerance sub-module 318 checks the status of the servers to determine if the CPU usage of each server is out of tolerance when compared to the tolerances set in the PKI Setup DB 334. The operation of Server Tolerance sub-module 318 is discussed in more detail in the description of FIG. 15. The Check Tolerances module then returns to Redundancy Server Status sub-module 316 and repeats. This branch of the Check Tolerances module represents the process for local servers that are in tolerance.

If step 421 determines that the network was not in status, a new temp_time is set with the currently obtained “Time” value (see step 414) in step 422 and saved in Tolerance & Status DB 334 (on each server in a redundant system) using Open Database sub-module 302, Structure DB Save Function sub-module 313, and Close Database Function sub-module 304. The operations of these sub-modules will be discussed in more detail in the descriptions of FIGS. 8, 13, and 9, respectively. Then, Server Tolerance sub-module 318 checks the status of the servers to determine if the CPU usage of each server is out of tolerance when compared to the tolerances set in the Tolerance & Status DB 334. The operation of Server Tolerance sub-module 318 is discussed in more detail in the description of FIG. 15. This branch of the Check Tolerances module represents the process for local servers that are out of tolerance.

Returning to step 418, if “Time” is less than “Temp_Time” plus “Wait_Time”, a new temp_time is set with the currently obtained “Time” value (see step 414) in step 422. Temp_Time is then saved in Tolerance & Status DB 334 (on each server in a redundant system) using Open Database sub-module 302, Structure DB Save Function sub-module 313, and Close Database Function sub-module 304. The operations of these sub-modules will be discussed in more detail in the descriptions of FIGS. 8, 13, and 9, respectively. Then, Server Tolerance sub-module 318 checks the status of the servers to determine if the CPU usage of each server is out of tolerance when compared to the tolerances set in the Tolerance & Status DB 334. This branch of the Check Tolerances module represents the process for local servers that are out of tolerance.

In step 424, Check Tolerances module 104 determines if the local server is the ‘Active’ Server from the list of servers obtained from PKI Setup DB 336 (see step 404). If the local server is not the ‘Active’ server, Assume Processes sub-module 320 assumes any processes assigned to the local server and reassigns them if possible. If the local server is the ‘Active’ server, Restore Processes sub-module 322 assumes any processes that have be re-assigned to other servers and re-assigns them to the local server. The Check Tolerances module then returns to Redundancy Server Status sub-module 316 and repeats.

FIG. 5 is flowchart of ODBC Search Function sub-module 306 according to one embodiment of the invention. ODBC Search Function sub-module 306 is used to search the ODBC-compliant databases for a specified search string. ODBC Search Function sub-module 306 may search for plain text and/or encrypted search strings and returns a list of the records that match the search string.

First in step 502, a search string is passed to ODBC Search Function sub-module 306 by the specific program, module or sub-module that called the ODBC Search Function sub-module. In step 514, the local databases (ODBC Databases 112 and ODBC Extended Databases 114) are opened using any conventional programming techniques. Preferably, a database index for each of the databases is also obtained. In step 516, the local databases are searched using the index and the plain text search string. The search may be conducted using any conventional programming techniques.

In step 518, it is determined if the search string was found. If yes, a FIFO (first-in, first-out) list of records found is created in step 520. Step 522 then checks if the returned record in the FIFO list is the last record in the database. If no, the search is continued in step 524. If step 522 determines that the returned record in the FIFO list was the last record in the database, the databases are closed in step 528 using any conventional programming techniques. Then in step 599, a list of records that contains the search string is returned.

Returning to step 518, if no records are found (or no more records are found) that contain the search string, step 526 checks if any records were found in the searching process. If yes, the databases are closed in step 528 using any conventional programming techniques. Then in step 599, a list of records that contains the search string is returned.

If step 526 determines that no records were found, the ODBC Search Function sub-module continues the search for the search string, but now uses an encrypted search string. First, the search string is encrypted using Encryption Function sub-module 326. The operation of Encryption Function sub-module 326 will be discussed in more detail in the description of FIG. 19. In step 530, the local databases are searched using the index and the encrypted search string. The search may be conducted using any conventional programming techniques.

In step 532, it is determined if the encrypted search string was found. If yes, a FIFO (first-in, first-out) list of records found is created in step 534. Step 536 then checks if the returned record in the FIFO list is the last record in the database. If no, the search is continued in step 538. If step 536 determines that the returned record in the FIFO list was the last record in the database, the databases are closed in step 542 using any conventional programming techniques. Then in step 599, a list of records that contains the search string is returned.

Returning to step 532, if no records are found (or no more records are found) that contain the encrypted search string, step 540 checks if any records were found in the searching process. If yes, the databases are closed in step 542 using any conventional programming techniques. Then in step 599, a list of records that contains the search string is returned. If step 540 determines that no records were found, the databases are closed in step 542 using any conventional programming techniques. Then in step 598, a message is returned that no records were found.

FIG. 6 is a flowchart of Post Events module 108 according to one embodiment of the invention. Post Events module 108 uses the Data Security module 103 functions to process the events and manual requests from the user to communicate between the co-operating devices (servers 101 and processor panels 104).

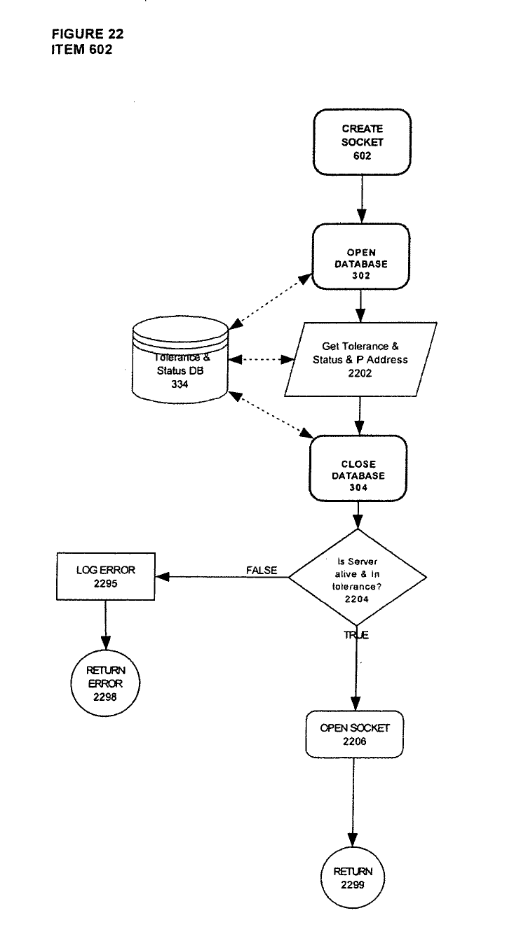

First, Create Socket sub-module 602 creates a socket. A socket establishes a communications path between two devices (e.g., server 101 to server 101, server 101 to processor panel 140). Create Socket sub-module 602 checks Tolerance & Status DB 334 to determine if the recipient co-operating device is alive and within tolerance. Create Socket sub-module 602, also gets the IP address from the Tolerance & Status DB (334) of the recipient device. The operation of Create Socket sub-module 602 will be discussed in more detail in the description of FIG. 22.

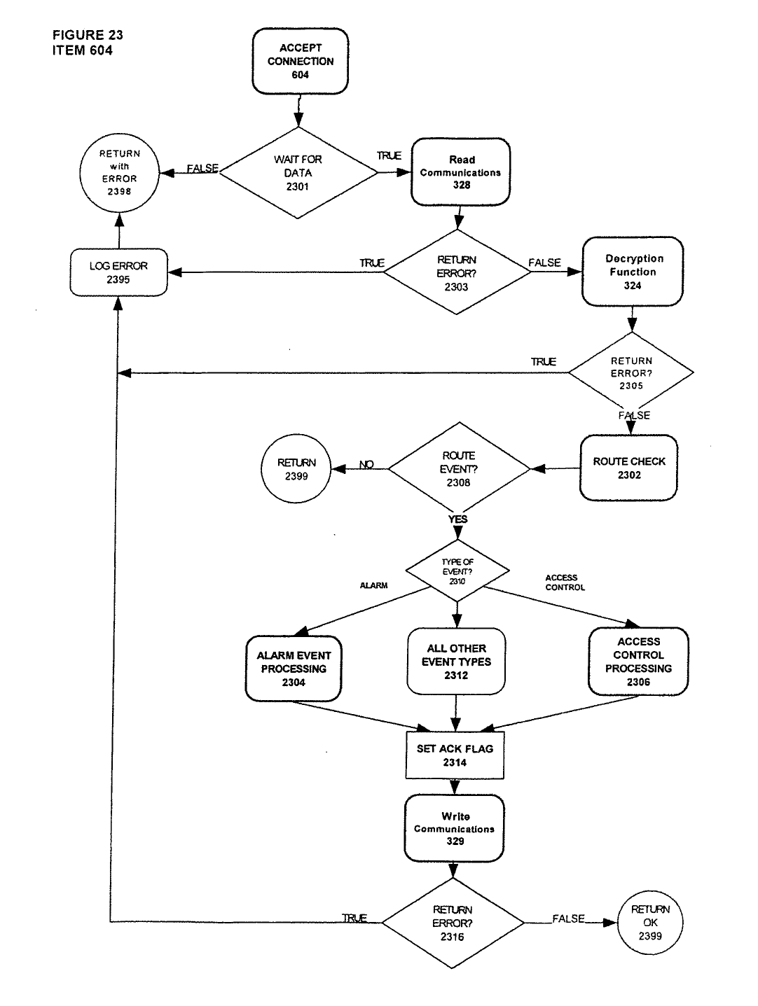

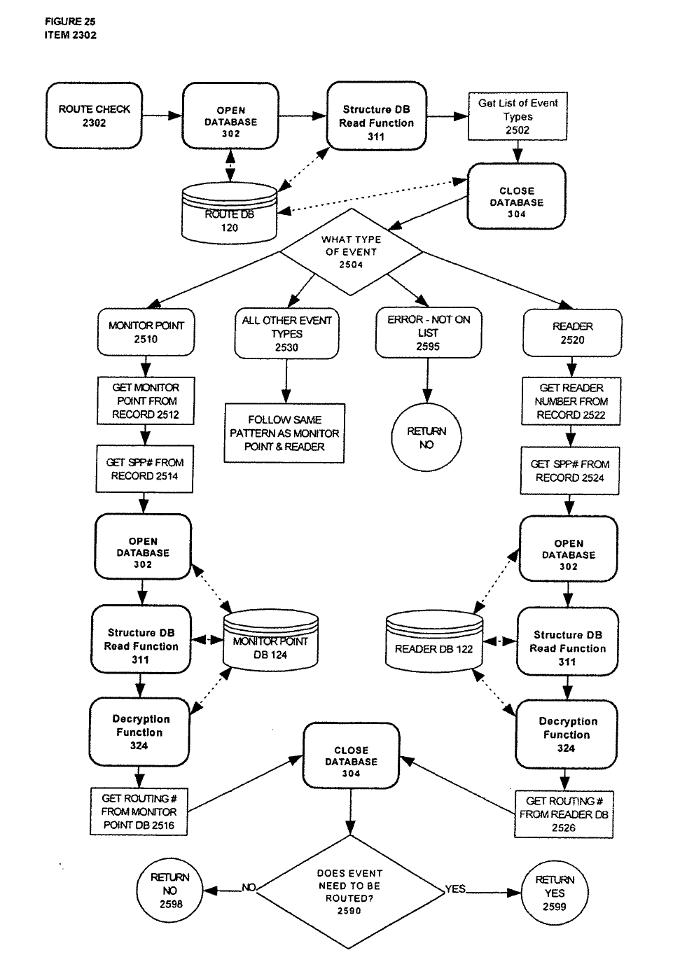

Then Accept Connection sub-module 604 receives packets of data from a co-operating device. Accept Connection sub-module 604 uses Read Communications sub-module 328 to read the data. Accept Connection sub-module 604 decrypts the data and processes the data through Route Check sub-module 2302 (see FIG. 25). Accept Connection determines the type of event and routes the event for processing. The operation of Accept Connection sub-module 604 will be discussed in more detail in the description of FIG. 23.

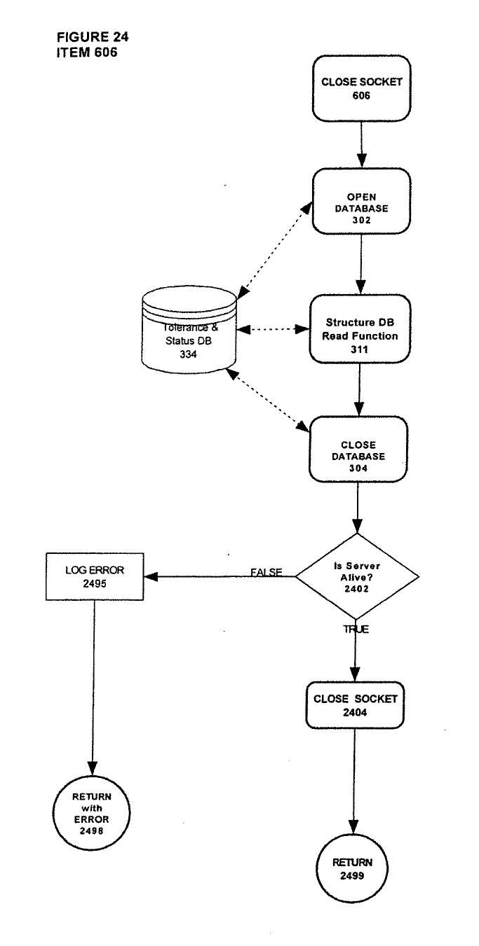

In step 605 it is determined if there was an error in connecting the co-operating device. If there was an error, Close Socket sub-module 606 closes the socket and the error is logged in step 610. A new attempt is then made to process the event until the event process has been completed successfully. Close Socket sub-module 606 verifies that the server with the connection is still alive before attempting to close the socket. The operation of Close Socket sub-module 606 will be discussed in more detail in the description of FIG. 24. If there was not an error connecting, Close Socket sub-module 606 closes the socket. Then in step 608, it is determined if the socket was closed properly. If not, an error is logged in step 610 and the Post Events module loops back to the beginning. If the socket was closed properly, the Post Events module loops back to the beginning.

FIG. 7 is a flowchart of ODBC Pack Function sub-module 308 according to one embodiment of the invention. ODBC Pack Function sub-module 308 is used to delete and condense databases where records have been marked for deletion. ODBC Pack Function sub-module 308 packs and re-indexes both the ODBC and its associated Extended ODBC database. Preferably, this sub-module is employed when no other operators or user logged into the system.

First, Tolerance & Status DB 334 is opened with Open Database sub-module 302. Then in step 702, the Tolerance & Status DB 334 is opened on the local server. Next in step 704, a current list of ‘Alive’ servers within tolerance and path are obtained from the local Tolerance and Status DB 334. A Server that is “alive” is able to communicate with the co-operating items (servers and panels). Close Database sub-module 304 then closes the open databases.

In step 712, the first server on the list and in the path of the local server is identified. In step 714, ODBC Database(s) 112 and associated ODBC Extended Database(s) 114 located in the first server are opened using any standard network communications. In step 716, the first record in ODBC Database 112 is read.

In step 718 it is determined if the obtained record has been marked for packing. If yes, the primary key that connects the Extended ODBC Database record to the current record that is marked for deletion is obtained. In step 722, the record is deleted in ODBC Database 112 Deletion may be effected using any conventional programming techniques. In step 723 it is determined if there was an error in deleting the record. If yes, step 782 closes the ODBC databases and step 798 returns with an error. If there was no error in deleting, step 724 locates the record in the ODBC Extended Database 114 using the primary key from the record in ODBC database 112 that was previously deleted. The located record in ODBC Extended Database 114 is then deleted in step 726 using any conventional programming techniques. An error in deletion is again determined in step 723. If yes, step 782 closes the ODBC databases and step 798 returns with an error.

If no, step 728 checks if the current record is the last record in ODBC database 112. If yes, step 729 re-indexes both ODBC Database 112 and ODBC Extended Database 114 using any conventional programming techniques. The ODBC databases are then closed in step 782. Step 730 then determines if the current server is the last server on the list (see step 704). If not, the ODBC Pack Function sub-module loops back to step 729. If yes, the sub-module returns in step 799. Returning to step 728, if the current record is not the last record in the database, step 780 obtains the next record in ODBC Database 112 and the sub-module loops back to step 718.

Returning to step 718, if the current record is not marked for packing, the sub-module proceeds directly to step 728 and proceeds as described above.

FIG. 8 is a flowchart of Open Database sub-module 302 according to one embodiment of the invention. Open Database sub-module 302 is used to open the databases on each server (in a redundant system). Open Database sub-module 302 is configured to open both ODBC and structured databases on any or all servers that are alive (i.e., within tolerance/predetermined activity threshold).

First, in step 806, it is determined if the database to be opened is a structured database or an ODBC database. Regardless of what type of database is determined, step 810 then determines if the system is redundant. Step 810 utilizes Tolerance & Status DB 334 to determine if the system is redundant. If the number of servers listed equals one, then the system is not redundant.

If step 806 determines that the database to be opened is a structured database and step 810 determines that the system is not redundant, Open Database sub-module 302 proceeds to step 840. Step 840 opens the local structured database (e.g., Structured Databases 110). Step 840 may use any conventional programming techniques to open a structured database. Then in step 899, a list of open databases is returned.

If step 806 determines that the database to be opened is an ODBC database and step 810 determines that the system is not redundant, Open Database sub-module 302 proceeds to step 830. Step 830 opens the local ODBC database (e.g., ODBC Databases 112). Step 830 may use any conventional programming techniques to open an ODBC database. Next, in step 822, the header field names of the local ODBC database are obtained. Any conventional programming techniques may be used to obtain the header field names. Next in step 824, the field location of the primary key is obtained. The primary key points to fields and/or records in Extended ODBC database 114 (for the current server) that are associated with fields and/or records in ODBC databases 112 (for the current server). In step 826, Extended ODBC Database 114 associated with the ODBC Database 112 is opened. This database may be opened using any conventional programming techniques. Then in step 899, a list of open databases is returned.

If step 806 determines that the database to be opened is a structured database and step 810 determines that the system is redundant, Open Database sub-module 302 proceeds to step 802. In step 802, Tolerance & Status DB 334 is opened on the local server. This database may be opened using any conventional programming techniques. In step 804, a list of servers that are “alive” and within tolerance is obtained. Step 804 also obtains the path to the servers. Prior to step 804, the contents of Tolerance & Status DB 334 are decrypted and then encrypted (i.e., after the data is obtained by step 804) with Decryption Function sub-module 324 and Encryption Function sub-module 326. The operation of Decryption Function sub-module 324 and Encryption Function sub-module 326 will be discussed in more detail in the description of FIGS. 18 and 19, respectively.

After the list of servers is obtained in step 804, step 812 gets the first server from the list and its path. Then in step 850, the structured database on the server selected by step 812 is opened. This database may be opened using any conventional programming techniques. In step 828, it is determined if the current server is the last server on the list. If not, the next server on the list (and its path) is obtained in step 829 and then steps 850 and 828 repeat. If step 828 determines that the current server is the last server on the list, the list of open databases is returned in step 899.

If step 806 determines that the database to be opened is an ODBC database and step 810 determines that the system is redundant, Open Database sub-module 302 proceeds to step 802. In step 802, Tolerance & Status DB 334 is opened on the local server. This database may be opened using any conventional programming techniques. In step 804, a list of servers that are “alive” and within tolerance is obtained. Step 804 also obtains the path to the servers. Prior to step 804, the contents of Tolerance & Status DB 334 are decrypted and then encrypted (i.e., after the data is obtained by step 804) with Decryption Function sub-module 324 and Encryption Function sub-module 326. The operation of Decryption Function sub-module 324 and Encryption Function sub-module 326 will be discussed in more detail in the description of FIGS. 18 and 19, respectively.

After the list of servers is obtained in step 804, step 812 gets the first server from the list and its path. Then in step 820, the ODBC database (i.e., ODBC database 112) on the server selected by step 812 is opened. This database may be opened using any conventional programming techniques. In step 822, header and field names of ODBC database 112 on the current server are obtained. The header and field names may be obtained using any conventional programming techniques. Next in step 824, the field location of the primary key is obtained. The primary key points to fields and/or records in Extended ODBC Database 114 (for the current server) that are associated with fields and/or records in ODBC Databases 112 (for the current server). Then in step 826, Extended ODBC database 114 is opened on the current server. In step 828, it is determined if the current server is the last server on the list. If not, the next server on the list (and its path) is obtained in step 829 and then steps 820, 822, 824, 826 and 828 are repeated. If step 828 determines that the current server is the last server on the list, the list of open databases is returned in step 899.

FIG. 9 is a flowchart of Close Database sub-module 304 according to one embodiment of the invention. Close Database sub-module 304 closes the ODBC & Structure databases on any or all servers that are open and “alive.”

First in step 902, it is determined if the database to be closed is a structured database or an ODBC database. Regardless of the type of database, Close Database sub-module 304 proceeds to step 904 where it is determined if the system is redundant.

If the database to be closed is a structured database and the system is not redundant, Close Database sub-module 304 proceeds to step 930. In step 930, the structured database is closed using any conventional programming techniques. The sub-module returns in step 999. If the database to be closed is a structured database and the system is redundant, Close Database sub-module 304 proceeds to step 940. In step 940, the name and path of the first server of the redundant system is obtained. Then in step 942, the structured database is closed on that server using any conventional programming techniques. In step 944, if the current server is the last server, the sub-module returns in step 999. If not, step 946 obtains the name and path of the next server in the system and steps 942 and 944 repeat.

If the database to be closed is an ODBC database and the system is not redundant, Close Database sub-module 304 proceeds to step 920. In step 920, the ODBC database is closed using any conventional programming techniques. The sub-module returns in step 999. If the database to be closed is an OBDC database and the system is redundant, Close Database sub-module 304 proceeds to step 910. In step 910, the name and path of the first server of the redundant system is obtained. Then in step 912, the ODBC database is closed on that server using any conventional programming techniques. In step 914, if the current server is the last server, the sub-module returns in step 999. If not, step 916 obtains the name and path of the next server in the system and steps 912 and 914 repeat.

FIG. 10 is a flowchart of ODBC Read Function sub-module 310 according to one embodiment of the invention. ODBC Read Function sub-module 310 reads data stored in an ODBC database. First in step 1002, the name and path of the first server in the redundant system is obtained. For non-redundant systems, there will be only one server. Using the path letter assigned to the server, ODBC Read Function sub-module 310 opens a standard communication path. In step 1004, a list of which fields in the ODBC database to be read are encrypted. This information is obtained from PKI Setup DB 336. Next, in step 1006, it is determined if the read request came internally from the software or from a user. If it is determined the request came from a user, a list of fields that have been designated as viewable by the requesting user is created in step 1008. Step 1008 may also create a list of fields that the requesting user may edit or create. This information is obtained from PKI Setup DB 336. Then, a list of fields to be decrypted is created in step 1010 (restricted for the specific user) or step 1012 (unrestricted). Step 1010 may place a symbol (e.g., “***”) or the word “ENCRYPTED” in the data fields that are encrypted.

In step 1016, the primary key for ODBC database 112 is obtained. Next, ODBC Search Function sub-module 306 searches the ODBC database 112 for the record and/or field to be read. The field or record to be read may come from a user request or from another software module or sub-module. Then in step 1014, the requested record and/or field is obtained from ODBC Database 112 on the current server. Then in step 1018, the associated record and/or field is obtained from ODBC Extended Database 114 using the primary key. In step 1020, the first field to be decrypted is obtained from the list generated in step 1010 or 1012. That field is then decrypted using Decryption Function sub-module 324. The operation of Decryption Function sub-module 324 will be discussed in more detail in the description of FIG. 18. In step 1022, the decrypted data from ODBC Extended Database 114 is merged with the associated record in ODBC Database 112. That is, the decrypted data may be stuffed into a record and/or field in the ODBC Database 112. Alternatively, step 1022 may write the decrypted data from ODBC Extended Database 114 into temporary memory.

In step 1024 it is determined if the current field is the last field in the list. If yes, the decrypted ODBC record is returned in step 1099. If no, step 1026 obtains the next field in the list and Decryption Function sub-module 324, step 1022, and step 1024 are repeated for the next field.

FIG. 11 is a flowchart of Structure DB Read Function sub-module 311 according to one embodiment of the invention. Structure DB Read Function sub-module 311 reads and decrypts data from structured databases, such as Structured Databases 110.

In step 1102, the name and path of the first server in the redundant system (may be one server for non-redundant systems) is obtained. Using the path letter assigned to the server, Structure DB Read Function sub-module 311 opens a standard communication path. In step 1104, data is read from Structured Databases 110 using any standard read functions for structured databases. Then Decryption Function sub-module 324 decrypts the read data. This data may be one or more records and/or fields. Then in step 1199, the decrypted record and the name and path of the server where the data was located is returned.

FIGS. 12A and 12B are a flowchart of ODBC Save Function sub-module 312 according to one embodiment of the invention. ODBC Save Function sub-module 312 saves and encrypts for ODBC databases. ODBC Save Function sub-module 312 saves and encrypts data for ODBC (or other relational databases) by extracting data in a field (or receiving new data) that is to be encrypted and storing it in a structural database (e.g., ODBC Extended Databases 114) in an encrypted format. This information is linked with a primary key that is created by standard programming functions. ODBC Save Function sub-module 312 stores in the original record of the ODBC Database 112 either the word “Encrypted” or a symbol (e.g., “****”).

First in step 1202, a list of fields and/or records that require data to be encrypted is obtained from PKI Setup DB 336. PKI Setup DB 336 may be encrypted, and as such, Decryption Function sub-module 324 may be used. In step 1203, the first field and/or record that has been requested to be saved is obtained.

In step 1204, that record and/or field is compared to the list generated in step 1202 to determine if it needs to be encrypted. If yes, Encryption Function sub-module 326 encrypts the data to be saved and that data is stuffed into a record and/or field of an Extended ODBC Database 114 in step 1206. Step 1208 tags a record and/or field in ODBC Database 112 with the word “Encrypted” or with a symbol. The tagged record and/or field will be associated with the record and/or field in the ODBC Extended Database 114 with a primary key. If the data to be saved does not need to be encrypted, step 1210 stuffs the record and/or field in ODBC Database 112 with plaintext.

Next, in step 1212, it is checked if the current field and/or record is the last field and/or record to be saved. If no, the next field and/or record are obtained in step 1214 and the ODBC Save Function sub-module returns to step 1204. If yes, the sub-module proceeds to step 1216 where it is determined if the system is redundant.

If step 1216 determines that the system is not redundant, step 1250 checks if any of the fields to which data is to be saved are encrypted fields. If yes, step 1233 checks to see if there is a primary key. If no, a primary key is created in step 1218. The primary key links specific fields and/or records of ODBC Extended Databases 114 (a structural database) with specific fields and/or records of ODBC Database 112. Then in step 1220, the data (the tag from step 1208 or plaintext from step 1210) for each field and/or record that was requested to be saved is written to the appropriate ODBC database 112 on the local server. If step 1233 determines that there is a primary key, the ODBC Save Function sub-module proceeds directly to step 1220. Next in step 1222, the encrypted data for each field and/or record requested to be saved is written to ODBC Extended Database 114 on the local server. The sub-module then returns in step 1299.

If step 1250 determines that no fields are to be encrypted, the data (the tag from step 1208 or plaintext from step 1210) for each field and/or record that was requested to be saved is written to the appropriate ODBC database 112 on the local server in step 1220.

Returning to step 1216, if the system is determined to be redundant, ODBC Save Function sub-module 312 proceeds to step 1230 in FIG. 12B. Step 1230 obtains a list of all servers that are “Alive” and within tolerance from Tolerance & Status DB 334. Step 1232 then obtains the name and path of the first server on the list. Next, step 1250 checks if any of the fields to which data is to be saved are encrypted fields. If yes, step 1233 checks to see if there is a primary key. If no, a primary key is created in step 1218. The primary key links specific fields and/or records of ODBC Extended Databases 114 (a structural database) with specific fields and/or records of ODBC Database 112. Then in step 1236, the data (the tag from step 1208 or plaintext from step 1210) for each field and/or record that was requested to be saved is written to the appropriate ODBC database 112 on the current server. If step 1233 determines that there is a primary key, the ODBC Save Function sub-module proceeds directly to step 1236. Next, regardless of whether or not a key needed to be created, the encrypted data for each field and/or record requested to be saved is written to ODBC Extended Database 114 on the current server in step 1238.

Next in step 1240, it is determined if the current server is the last server on the list. If yes, the sub-module returns in step 1299. If no, step 1242 gets the next server on the list and the sub-module returns to step 1236. Each subsequent server on the list may utilize the same primary key (if necessary) created for the first server in step 1218. However, a new primary key may be created for each server.

Returning to step 1250, if none of the fields are to be encrypted, ODBC Save Function sub-module proceeds to step 1220 where the data (the tag from step 1208 or plaintext from step 1210) for each field and/or record that was requested to be saved is written to the appropriate ODBC database 112 on the local server. Next in step 1240, it is determined if the current server is the last server on the list. If yes, the sub-module returns in step 1299. If no, step 1242 gets the next server on the list and the sub-module returns to step 1220.

FIG. 13 is a flowchart of Structure DB Save Function sub-module 313 according to one embodiment of the invention. Structure DB Save Function sub-module 313 saves and encrypts for structured databases.

First in step 1304, the sub-module determines if the system is redundant. If not, Encryption Function sub-module 326 encrypts the data to be saved and saves the data to a structured database (e.g., Structured Databases 110) on the HDD of the local server in step 1308. In step 1310, the record and/or field in which the encrypted data was saved is tagged indicating that data was saved. Then in step 1399, Structure DB Save Function sub-module 313 returns with a list of saved records.

If step 1304 determines that the system is redundant (i.e., more than one server is listed in the Tolerance & Status DB 334), step 1306 gets the name and path of the first server in the redundant system. Then, Encryption Function sub-module 326 encrypts the data to be saved and saves the data to a structured database (e.g., Structured Databases 110) on the HDD of the current server in step 1308. In step 1310, the record and/or field in which the encrypted data was saved is tagged indicating that data was saved. Step 1312 determines if there are more servers left in the redundant system. If yes, step 1314 obtains the name and path of the next server. If not, a list of saved records is returned in step 1399.

FIG. 14 is a flowchart of Redundancy Server Status sub-module 316 according to one embodiment of the invention. Redundancy Server Status sub-module 316 checks the status of the servers to determine if they are “Alive” Or “Inactive.” A status of “Alive” indicates that the server is able to communicate with the redundant system. A status of “Inactive” indicates that the server is unable to communicate with the redundant system.

First, PKI Setup DB 336 is opened with Open Database sub-module 302. Then in step 1402, a list of servers and their respective paths are obtained from the opened PKI Setup DB 336. Step 1404 then checks if the system is redundant. If not, Close Database sub-module 304 is used to close PKI Setup DB 336 and the Redundancy Server Status sub-module returns.

If the system is determined to be redundant in step 1404, the name and path of the first server in the list is obtained in step 1406. Using the obtained path, a standard communication path is opened to that server. Next, Close Database sub-module 304 closes PKI Setup DB 336. Next in step 1408, it is determined if the current server is “Alive.” If the sub-module was able to open a communication path to the current server and is able to communicate with that server it is determined to be “Alive.” If a communication path is not established and/or communication not received, the server is determined to be “Inactive.”

If the server is determined to be alive, Open Database sub-module 302 opens Tolerance & Status DB 334 located on the current server and step 1410 updates the database to indicate that the current server is “Alive.” Next it is determined if the current server is the last server on the list in step 1412. If yes, Close Database sub-module 304 closes Tolerance & Status DB 334 on the current server and the Redundancy Server Status sub-module 313 returns in step 1499. If the current server is not the last server on the list, Close Database sub-module 304 closes Tolerance & Status DB 334 on the current server and step 1414 obtains the name and path of the next server on the list. Redundancy Server Status sub-module 313 then returns to step 1408.

If the server is determined not to be alive in step 1408, Open Database sub-module 302 opens Tolerance & Status DB 334 located on the current server and step 1420 updates the database to indicate that the current server is “Inactive.” Next it is determined if the current server is the last server on the list in step 1412. If yes, Close Database sub-module 304 closes Tolerance & Status DB 334 on the current server and the Redundancy Server Status sub-module 313 returns in step 1499. If the current server is not the last server on the list, Close Database sub-module 304 closes Tolerance & Status DB 334 on the current server and step 1414 obtains the name and path of the next server on the list. Redundancy Server Status sub-module 313 then returns to step 1408.

FIG. 15 is a flowchart of Server Tolerance sub-module 318 according to one embodiment of the invention. Server Tolerance sub-module 318 checks the status of the servers to determine if the CPU usage of each server is out of tolerance when compared to the tolerances set in PKI Setup DB 334.

First, Open Database sub-module 302 opens Tolerance & Status DB 334. Then, utilizing Structure DB Read Function sub-module 311, step 1502 obtains a list of servers, their respective paths, and their status (i.e., “Alive” or “Inactive”) indicated in Tolerance & Status DB 334. Close Database sub-module 304 then closes Tolerance & Status DB 334.

Next, Open Database sub-module 302 opens PKI Setup DB 336. Then, utilizing Structure DB Read Function 311, step 1504 obtains server names, their respective paths, and their respective server tolerances from the database. The server tolerances indicate what levels of activity (e.g., CPU usage) would cause a server to be considered out of tolerance. Then, Close Database sub-module 304 closes PKI Setup DB 336.

Next in step 1506, the current activity of each server is compared to the tolerance obtained from PKI Setup DB 336. Step 1508 then determines if any server in the system is out of tolerance based on the comparison. If no, Server Tolerance sub-module 302 returns in step 1599. If yes, step 1510 creates a list of servers and their respective paths that were determined to be out of tolerance. Then in step 1512, the first “out of tolerance” server and its respective path is obtained from the list.

Next in step 1514, the current server from the “out of tolerance” list is checked to see if it is the “Active” server. The “Active” server is the server that is currently assigned to perform the tasks of the data security system. If the current server is not the “Active” server, step 1540 checks to see if the current server is the last server on the “out of tolerance” list. If yes, Server Tolerance sub-module 318 returns in step 1599. If no, step 1542 obtains the name and path of the next server on the “out of tolerance list” and returns to step 1514.

If it is determined in step 1514 that the current server is the “Active” server, step 1530 then retrieves the list of active processes for this server. These are all the processes that the current server is currently being asked to perform. The list of these processes is stored in Tolerance & Status DB 334. Then in step 1532, a list of servers, their respective paths, and their redundancy order is obtained from Tolerance & Status DB 334. In step 1534, the first process in the list created in step 1530 is turned off for the current server and the process is then tagged (i.e., to be reassigned) to the next server in the redundancy chain determined in step 1532. This reassignment is stored in Tolerance & Status DB 334. Then, utilizing Open Database sub-module 302, Structure DB Save Function sub-module 313, and Close Database sub-module 304, the current processes being executed by the servers as altered by steps 1534 and 1536 are stored on the Tolerance & Server DB on all servers in the system. Server Tolerance sub-module 318 then loops back to the beginning. In this way, the tolerance level of the “Active” server may again be checked before reassigning a second process.

FIG. 16 is a flowchart of Assume Processes sub-module 320 according to one embodiment of the invention. Assume Processes sub-module 320 completes the reassignment of processes tagged by Server Tolerance sub-module 318.

First, using Open Database sub-module 302 and Structure DB Read Function 311, step 1602 reads Tolerance & Status DB 334 to determine if any processes have been tagged for the current server (i.e., the server calling the Assume Processes sub-module). If no, Close Database sub-module 304 closes Tolerance & Status DB 334 and the returns.

If yes, Close Database sub-module 304 closes Tolerance & Status DB 334. Then, Open Database sub-module 302 opens PKI Setup Database 336. Next in step 1604, the activity level of the current server is obtained and compared to the tolerances levels set in PKI Setup DB for the current server. Close Database sub-module 304 then closes PKI Setup DB 336.

Based on the activity level and tolerances obtained in step 1604, step 1606 determines if the current server is out of tolerance. If yes, Tolerance & Status DB 334 is opened and read by Open Database sub-module 302 and Structure DB Read Function sub-module 311, respectively. Structure DB Read Function sub-module 311 is used to obtain the redundancy order. Then in step 1620, the process tagged for the current server is now tagged to the next server in the obtained redundancy order. Then, Structure DB Save Function 313 saves the tag to Tolerance & Status DB 334 on all servers. Close Database sub-module 304 is used to close each Tolerance & Status DB 334 and Assume Processes sub-module 320 returns in step 1699.

If the current is server is determined not to be out of tolerance in step 1606, Tolerance & Status DB 334 is opened and read by Open Database sub-module 302 and Structure DB Read Function sub-module 311, respectively. Then in step 1610, the process tagged for the current server is turned on. Then, Structure DB Save Function 313 saves the status of this processor (i.e., “On”) to Tolerance & Status DB 334 on all servers. Close Database sub-module 304 is used to close each Tolerance & Status DB 334 and Assume Processes sub-module 320 returns in step 1699.

FIG. 17 is a flowchart of Restore Processes sub-module 322 according to one embodiment of the invention. Restore Processes sub-module 322 restores processes to the “Active” server that were previously reassigned because the “Active” server was not “Alive” or was out of tolerances.

First, using Open Database sub-module 302 and Structure DB Read Function 311, step 1702 obtains a list of servers, their respective paths, their status, and tolerances from Tolerance & Status DB 334. DB 334 is then closed using Close Database sub-module 304. In step 1704, it is determined if the current server (i.e., the server calling the Restore Processes sub-module) is the “Active” server. If no, Restore Processes sub-module 322 returns in step 1799. If the current server is the active server, step 1706 then determines if the current server is in control of all of its process. This may be done, for example, by checking data stored in Tolerance & Status DB 334 to determine if any processes that are the responsibility of this server have been reassigned to another server.

If the current server is in control of all of its processes, Restore Processes sub-module 322 returns in step 1799. If the current server is not in control of all of its processes, step 1706 opens PKI Setup DB 336, obtains a list of servers, their respective paths, and their respective tolerance levels, and closes the database using Open Database sub-module 302, Structure DB Read Function sub-module 311, and Close Database sub-module 304. Then in step 1710, the activity level of the current server is obtained and compared to the tolerances obtained in step 1708. Based on this comparison, step 1712 determines if the current server is out of tolerance. If yes, the sub-module returns in step 1799. If no, step 1714 obtains a list of re-assigned processes for the current server (which is the “Active” server) from Tolerance & Status DB 334 on all servers. Step 1716, the first process on this list is removed from the server to which it was reassigned and is restored to the current server. The status of the processes is then saved on Tolerance & Status DB 334 on all servers using Structure DB Save Function 313. Close Database sub-module then closes DB 334 on all servers. Restore Processes sub-module 322 then loops back to step 1702. In this way, reassigned processes are restored on the “Active” server one at a time with a check of usage levels against predetermined tolerances between each restoration. However, it is also acceptable to restore two or more processes to an “Active” server between out of tolerance determinations.

FIG. 18 is a flowchart of Decryption Function sub-module 324 according to one embodiment of the invention. Decryption Function sub-module 324 is used to decrypt data stored in the database. In this example, the Decryption sub-module utilizes a public key/private key encryption system as set forth by FIPS 140-2 or FIPS 140-3. However, this invention and this embodiment may use any encryption system.

First in step 1802 the public key is obtained. In a FIPS 140-2 or 140-3 encryption system, the public key may be supplied by the U.S. Government. A user may also create a public key. This key may be buried within the software (that is stored within the executable code) rather than in a database so that it is not identifiable. Then, Open Database sub-module 302 opens Private Key DB 330. Step 1804 reads Private Key DB 330 and step 1808 obtains the private keys needed for decrypting the requested fields and/or records from Private Key DB 330. Close Database sub-module 304 then closes Private Key DB 330. The private keys are created by the user (preferably the administrator) of the system. The private keys may be assigned or associated to different users or groups of users so that access to data may be controlled on a user by user basis. Also, as each field and/or record of data may be encrypted with a different public key/private key pair, each field and/or record of data may then be decrypted with a different public key/private key pair.

In step 1809 it is determined what type of data is to be decrypted. This will be known from the database type as well as the header information for the fields and/or record to be decrypted. Data types may include character strings 1810, ODBC fields 1820, and VOID structures 1830. If the data type is a character string, step 1814 decrypts the data using the combined public key and private key associated with the data. This process may be repeated using several keys for different fields within the same database. If the data is an ODBC field, the field is copied into a string format in step 1824 before decrypting in step 1814. If the data is in a VOID structure format, the structure is copied into a string format in step 1834 before decrypting in step 1814.

Next in step 1811, it is again determined what type of data was requested to be decrypted. For character string 1810, step 1816 reformats the decrypted data into a character string. For ODBC string 1825, step 1826 reformats the decrypted string into an ODBC field. For VOID structure 1830, step 1836 copies the decrypted string into a VOID structure. Then in step 1899, the decrypted data is returned.

FIG. 19 is a flowchart of Encryption Function sub-module 326 according to one embodiment of the invention. Encryption Function sub-module 326 is used to encrypt data stored in the database. In this example, the Encryption sub-module utilizes a public key/private key encryption system as set forth by FIPS 140-2 or FIPS 140-3. However, this invention and this embodiment may use any encryption system.

First in step 1902 the public key is obtained. In a FIPS 140-2 or 140-3 encryption system, the public key may be supplied by the U.S. Government. The user may also create a public key. This key may be buried within the software (that is stored within the executable code) rather than in a database so that it is not identifiable. Then, Open Database sub-module 302 opens Private Key DB 330. Step 1904 reads Private Key DB 330 and step 1906 obtains the private keys needed for encrypting the requested fields and/or records from Private Key DB 330. Close Database sub-module 304 then closes Private Key DB 330. The private keys are created by the user (preferably the administrator) of the system. The private keys may be assigned or associated to different users or groups of users so that access to data may be controlled on a user by user basis. Also, each field and/or record of data may be encrypted with a different public key/private key pair.

In step 1908 it is determined what type of data is to be encrypted. This will be known from the database type as well as the header information for the fields and/or record to be decrypted. Data types may include character strings 1910, ODBC fields 1920, and VOID structures 1930. If the data type is a character string, step 1914 encrypts the data using the combined public key and private key associated with the data. This process may be repeated using several keys for different fields within the same database. If the data is an ODBC field, the field is copied into a string format in step 1924 before encrypting in step 1914. If the data is in a VOID structure format, the structure is copied into a string format in step 1934 before encrypting in step 1914.

Next in step 1908, it is again determined what type of data was requested to be encrypted. For character string 1910, step 1916 reformats the encrypted data into a character string. For ODBC string 1925, step 1926 reformats the encrypted string into an ODBC field. For VOID structure 1930, step 1936 copies the encrypted string into a VOID structure. Then in step 1999, the encrypted data is returned.

FIG. 20 is a flowchart of Read Communications sub-module 328 according to one embodiment of the invention. Read Communications sub-module 328 reads the data contained in records and/or fields of databases across a communications path.

First in step 2002, a first data packet is read. This data packet is received over a communication path (socket) from another co-operating device in the system (e.g., another server or a processor panel). The communication path may be created by the process shown in FIG. 22. Next, step 2004 checks to see if the current packet is the last packet. If no, step 2006 gets the next packet of data through the communications path. If the last packet has been received, step 2008 confirms that the data was received properly. Using standard programming functions, the record checksum from what was sent to what was received is verified. If the data was not received properly, the sub-module returns with an error (e.g., may display “Read Error”) in step 2098.

If the data was received properly, step 2010 converts that data into a structure format. Then in step 2012, the data type for decryption is set. This data type is then used by Decryption Function sub-module 324 to decrypt the data. Then in step 2014 the decrypted data is read and verified to determine if what was received was expected. In step 2016, an ACK Flag is set to verify that the Read Communications process was completed properly. The ACK flag is then sent to the device that sent the data. Read Communications sub-module 328 then returns in step 2099.

FIG. 21 is a flowchart of Write Communications sub-module 329 according to one embodiment of the invention. Write Communications sub-module 329 writes database files, fields and records to a file across a communication path.

First in step 2102, a time and date stamp is added to the field and/or record to be written. In step 2104, a “time out” flag is set in PKI Setup DB 336. This flag will be used to determine if the transfer of data has been completed within a predetermined length of time. In step 2106, the type of data is set for use by Encryption Function sub-module 326. Preferably, the data types include VOID structure, character string, or ODBC field (see FIGS. 18 and 19). Next, Encryption Function sub-module 326 encrypts the data to be written across the communication path.

In step 2108, the IP address of the recipient of the data to be written is obtained. The recipient may be another server 101 or a processor panel 140. Next, using Open Database sub-module 302 and Structure DB Read Function sub-module 311, step 2110 obtains status (i.e., “Alive” or “Inactive”) and tolerance information for the recipient from Tolerance & Status DB 334. Next, Close Database sub-module 304 is used to close Tolerance & Status DB 334. Based on the information obtained in step 2110, step 2112 determines if the recipient is “Alive.” If no, step 2198 returns with an error. If yes, step 2114 writes the encrypted record to the recipient device across the communication path. The communication path may be created by the process shown in FIG. 22.

Step 2116 then waits until the recipient device responds or the predetermined “time out” period has expired. If the “time out” period expires before the recipient device responds, step 2198 returns with an error. If the recipient responds first, Read Communications sub-module 328 reads the recipient's response. Step 2118 then determines if an ACK flag (acknowledges a valid transfer) was included in the recipient's response. If not, step 2198 returns with an error. If an ACK flag was received, step 2199 returns.

FIG. 22 is a flowchart of Create Socket sub-module 602 according to one embodiment of the invention. Create Socket sub-module 602 is used to create a communication path (i.e., a socket) between two co-operating devices in the system. First, Open Database sub-module 302 opens Tolerance & Status DB 334 and step 2202 obtains tolerance, status, and IP address for the device (server or processor panel) to which a communication path is to be opened. Close Database sub-module 304 then closes Tolerance & Status DB 334. Based on the status and tolerance information obtained in step 2202, step 2204 determines if the recipient device is “Alive” and within tolerance. If no, step 2295 logs an error step 2298 returns with an error. If yes, step 2206 opens the communication path (socket) using the obtained IP address and then step 2299 returns. Step 2206 may be performed using any conventional programming techniques.

FIG. 23 is a flowchart of Accept Connection sub-module 604 according to one embodiment of the invention. Accept Connection sub-module 604 receives packets of data from a co-operating device.

First, step 2301, using standard programming functions, waits for data to be sent. An error returns in step 2398 when a standard programming message is received from the socket indicating that the Operating System has closed the socket (typically a hardware error, e.g. a network card). If data is received, Read Communication sub-module 328 reads the received data. Step 2303 then determines if an error in the reading of the data occurred based on the output of Read Communication sub-module 328. If there was an error, step 2395 logs the error and step 2398 returns with an error. If there was not an error in reading the data, Decryption Function sub-module 324 is used to decrypt the read data. Based on the output of Decryption Function sub-module 324, step 2305 checks if there was an error in the decryption process. If yes, step 2395 logs the error and step 2398 returns with an error. If no, Route Check sub-module 2302 reads Route Database 120 and determines how to process the event (i.e., the data that has been received through the Accept Connection sub-module). Route Check sub-module 2303 returns the type of event and the data needed to process the event. The operation of Route Check sub-module 2302 will be discussed in more detail in the description of FIG. 25.

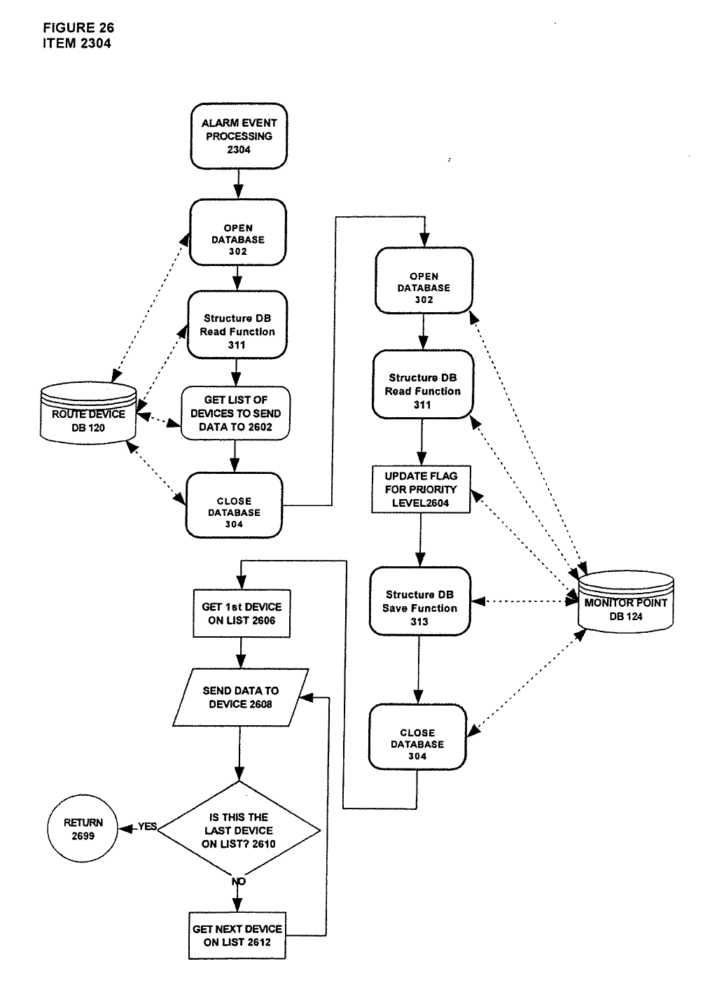

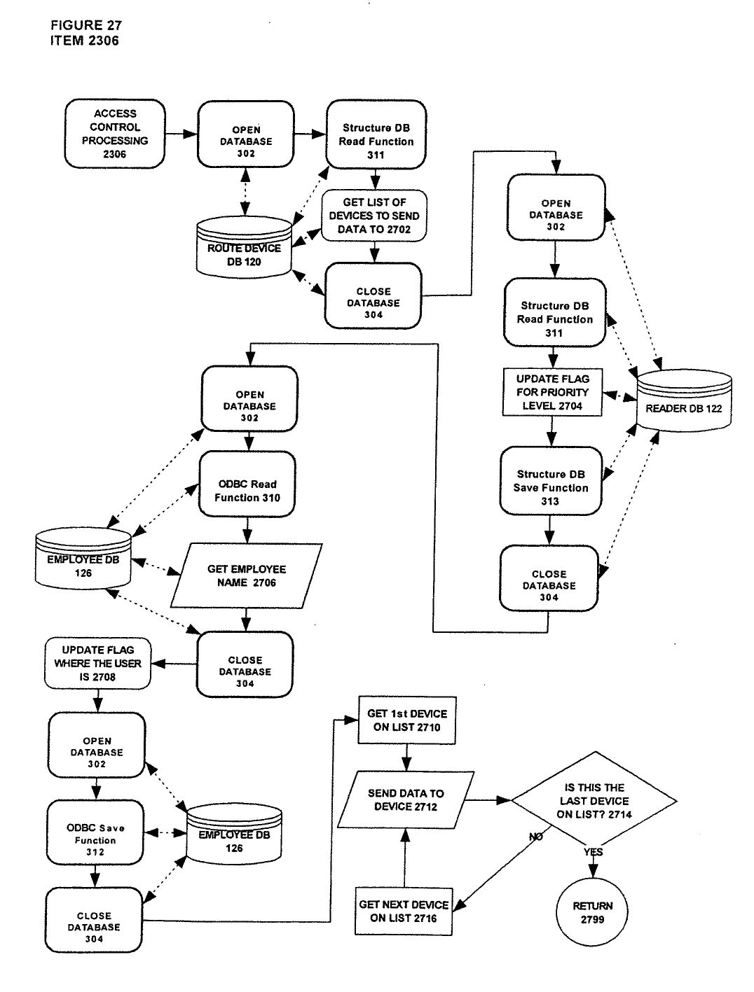

Based on the output of Route Check sub-module 2302, step 2308 determines if the event is a route event. A “Route Event” determination is true or false as to whether, under the current circumstances, an event is to be sent to other devices (e.g. a true statement is that a PIR (passive infrared) motion detector is set off during operating hours, a false statement is when the PIR motion detector is set off during closed hours). If the event is not a route event, step 2399 returns. If the event is a route event, step 2310 determines the type of event. Route events may include events that indicate an alarm has been tripped or a request to pass through an entry control portal (e.g., a controlled gate, door, etc.). This determination may trigger Alarm Event Processing sub-module 2304 (see FIG. 26), Access Control Processing sub-module 2306 (see FIG. 27), or another sub-module 2312 for some other type of event. Alarm Event Processing sub-module 2304 processes an alarm or event that has occurred within the system. An example of an alarm or event would be when a PIR motion detector is triggered in an area where no one is authorized to be at during the time of the event or alarm. Access Control Processing sub-module 2306 processes an alarm or event that has occurred within the system. For example, an Access Control event occurs when an access card is swiped by an individual requesting access to a building or area.

In step 2314, an ACK flag is set once the processing of the event is complete. Then, Write Communications sub-module 329 posts any data as required by the Processing functions (i.e., Alarm Event, Access Control, or Other) to the co-operating devices specified. Step 2316 then checks if Write Communications sub-module 329 returned with an error. If yes, step 2395 logs the error and step 2398 returns with an error. If no, step 2399 returns.

FIG. 24 is a flowchart Close Socket sub-module 606 according to one embodiment of the invention. Close Socket sub-module 606 closes an open socket. First, step 2402 verifies that the server (or another co-operating device such as a processor panel) is still “Alive.” The status of the server is found in Tolerance & Status DB 334. The status information is obtained by first opening DB 334 with Open Database sub-module 302, reading the desired status with Structure DB Read Function 311, and then closing DB 334 with Close Database sub-module 302. If the server was not alive, step 2495 logs an error and step 2498 returns with an error. If the server was alive, step 2404 closes the socket (i.e., communication path) and step 2499 returns. The socket may be closed using any conventional programming techniques.

FIG. 25 is a flowchart of Route Check sub-module 2302 according to one embodiment of the invention. Route Check sub-module 2302 determines, from the appropriate database, what actions the system needs to take when an event occurs.

First, using Open Database sub-module 302 and Structure DB Read Function sub-module 311, step 2502 obtains a list of the types of events from Route DB 120. Close Database 304 then closes Route DB 120. Step 2504 then determines what type of event needs to be processed based on the information received by Route Check sub-module 2302 and the obtained list of types of events the system is able to process. If the event to be processed is not on the list, step 2595 returns an error. Otherwise, Route Check sub-module 2302 continues.

FIG. 25 shows the process Route Check sub-module 2302 performs for alarm (monitor point) and access control (reader). If the type of event is Monitor Point event 2510, step 2512 obtains the name and location of the Monitor point (e.g., an alarm) from the data (record) received by Route Check sub-module 2302. Next, step 2514 obtains the SPP (Standalone Processor Panel) number from the data (record) received by Route Check sub-module 2302. Then step 2516 obtains the routing number from Monitor Point DB 124. The routing number is assigned to the routing path for a physical device to which events are sent for processing. Single or multiple devices may be contacted (e.g. Route #1 can be Terminal 1, Event Printer 2 and 3, etc). Step 2516 utilizes Open Database sub-module 302 to open Monitor Point DB 124, Structure DB Read Function sub-module 311 to read the record in Monitor Point DB 124 that contains the routing number, and Decryption Function sub-module 324 to decrypt that record. Next, Close Database sub-module 304 closes Monitor Point DB 124.

If the type of event is Reader 2520, step 2522 obtains the name and location of the Reader (e.g., a swipe card reader) from the data (record) received by Route Check sub-module 2302. Next, step 2524 obtains the SPP number from the data (record) received by Route Check sub-module 2302. Then step 2526 obtains the routing number from Reader DB 122. Step 2526 utilizes Open Database sub-module 302 to open Reader DB 122, Structure DB Read Function sub-module 311 to read the record in Reader DB 122 that contains the routing number, and Decryption Function sub-module 324 to decrypt that record. Next, Close Database sub-module 304 closes Reader DB 122.

The same process for monitor point and reader processes may be followed for other types of events 2530. Regardless of the type of event, the database used to obtain the routing number is then closed using Close Database sub-module 304. Step 2590, based on the obtained routing number, determines if the event needs to be routed. If no, step 2598 returns with a no answer. If yes, step 2599 returns with a yes answer.

FIG. 26 is a flowchart of Alarm Event Processing sub-module 2304 according to one embodiment of the invention. After Post Events module 108 receives an event and Route Check sub-module 2302 has determined that the event is an alarm (Monitor Point) event that needs processing, Alarm Event Processing sub-module 2304 processes the event.

First, step 2602 obtains a list of devices to send data regarding the alarm event from Route DB 120. Open Database sub-module 302 is used to open Route DB 120 and Structure DB Read Function sub-module 311 is used to read the record(s) that specify which devices should be sent data based on the type of event. Close Database sub-module 304 then closes Route DB 120. Next, Open Database sub-module 302 opens Monitor Point DB 124 and Structure DB Read Function sub-module 311 reads the database to determine the location of priority level flags. Step 2604 then updates the priority level flag based on the type of event. When an event comes in it is put into a queue, the module picks it up depending upon its priority level. The priority levels are customer defined (e.g. normally a fire alarm is the highest priority level). Structure DB Save Function sub-module 313 is then used to save the updated priority level flag in Monitor Point DB 124 and Close Database sub-module 304 closes Monitor Point DB 124.

Step 2606 then obtains the name and path of the first server on the list obtained in step 2602. Step 2608 then sends data regarding the event to the current device. The data may be sent using any data communication technique, including using the Write Communications sub-module. Devices may include a terminal display driver (e.g., for displaying an alarm event), an email server (e.g., for sending an email regarding an alarm event) or a printer driver (e.g., for printing information regarding an alarm event). Any device capable of communication with the system may be utilized for processing an alarm event.

Step 2610 then checks if the current device is the last device on the list. If yes, step 2699 returns. If no, step 2612 obtains the next device on the list obtained in step 2602 and then returns to step 2608.

FIG. 27 is a flowchart of Access Control Processing sub-module 2306 according to one embodiment of the invention. After Post Events module 108 receives a request (event) and the Route Check sub-module 2302 determines the event is a Reader event (i.e., access control) and the event needs routing, Access Control Processing sub-module 2306 processes the Access Control event. As one example, an Access Control Event may occur when an individual using some identification means (e.g., a card swipe) requests entry to a building or area.

First, step 2702 obtains a list of devices to send data regarding the alarm event from Route DB 120. Open Database sub-module 302 is used to open Route DB 120 and Structure DB Read Function sub-module 311 is used to read the record(s) that specify which devices should be sent data based on the type of event. Close Database sub-module 304 then closes Route DB 120. Next, Open Database sub-module 302 opens Reader DB 122 and Structure DB Read Function sub-module 311 reads the database to determine the location of priority level flags. Step 2704 then updates the priority level flag based on the type of event. Structure DB Save Function sub-module 313 is then used to save the updated priority level flag in Reader DB 122 and Close Database sub-module 304 closes Reader DB 122.

Step 2706 then obtains the name of the Employee who requested and/or was granted access during the event from Employee DB 126. Open Database sub-module 302 opens Employee DB 126, ODBC Read Function sub-module 310 reads the employee name from the database, and after obtaining the name in step 2706, Close Database sub-module 304 closes Employee DB 126. Next, based on the obtained employee name and the known location of the access control (reader) event, step 2708 updates a flag in Employee DB 126 that indicates the location of the employee. Step 2708 first opens Employee DB 126 with Open Database sub-module 302, saves the updated location flag to the database using ODBC Save Function sub-module 312, and closes the database with Close Database sub-module 304.

Step 2710 obtains the name and path of the first device found in the list created in step 2702. Step 2712 sends data regarding the access control (reader) event to the current device. The data may be sent using any data communication technique, including using the Write Communications sub-module. Devices may include a terminal display driver (e.g., for displaying an access control event), an email server (e.g., for sending an email regarding an access control event) or a printer driver (e.g., for printing information regarding an access control event). Any device capable of communication with the system may be utilized for processing an access control event.

Step 2714 then determines if the current device is the last device on the list. If yes, step 2799 returns. If no, step 2716 obtains the name and path of the next device on the list and returns to step 2712.

Other embodiments of the invention will be apparent to those skilled in the art from consideration of the specification and embodiments disclosed herein. Thus, the specification and examples are exemplary only, with the true scope and spirit of the invention set forth in the following claims and legal equivalents thereof.

1. A method of creating a data file containing encrypted data, the method comprising the steps of:
receiving a plaintext data having one or more data structures, each data structure having one or more fields containing plaintext data;
encrypting at least one field of plaintext data with an encryption algorithm to create encrypted data;
creating an encrypted data file; and
storing the encrypted data in the fields of the encrypted data file.

2. The method of claim 1 wherein the encrypted data file has the same number of data structures and fields as the plaintext data;

3. The method of claim 1 wherein the plaintext data is a database file.

4. The method of claim 1 wherein the encrypting step encrypts at least one field of plaintext data with an encryption algorithm that uses an encryption key.

5. The method of claim 4 wherein each field of plaintext data is encrypted with a different encryption key.

6. The method of claim 5 further comprising the step of:
storing, in a pointer data file, a pointer to the field in the encrypted data file in which the encrypted plaintext data was stored.

7. The method of claim 6 further comprising the step of:
encrypting the pointers stored in the pointer data file.

8. The method of claim 6 wherein the pointer data file is the plaintext data file.

9. The method of claim 5 further comprising the steps of:
creating an encryption key data file;
storing, in the encryption key data file, decryption keys capable of decrypting the encrypted plaintext data; and
associating a user with each decryption key.

10. The method of claim 9 wherein the decryption keys are the same as the encryption keys.

11. The method of claim 9 wherein the decryption keys are different than the encryption keys.

12. A method for decrypting an encrypted data file comprising the steps of:
providing an encrypted data file, the encrypted data file having two or more data structures, each data structure having one or more fields containing encrypted data;
receiving a request to decrypt encrypted data in one or more of the fields; and
decrypting the requested data into plaintext data.

13. The method of claim 12 further including the step of displaying the decrypted plaintext data, wherein the decrypted plaintext data is stored in temporary memory until it is displayed and then is deleted.

14. The method of claim 12 further comprising the steps of:
providing a pointer data file, the pointer data file containing pointers to fields in the encrypted data file;
associating the received request with pointers in the pointer data file, wherein the requested data is the encrypted data pointed to by the associated pointers.

15. The method of claim 12 further comprising the steps of:
providing an encryption key data file, the encryption key data file containing decryption keys used to decrypt the encrypted data in the encrypted data file;
associating a user with each encryption key.

16. The method of claim 15 wherein the encryption key data file contains a decryption key for each field of the encrypted data file.

17. The method of claim 15 wherein the decryption keys are the same as the encryption keys.

18. The method of claim 15 wherein the decryption keys are different than the encryption keys.

19. A method for sharing processes among two or more networked computers in real time, the method comprising the steps of:
(1) receiving a request to execute a process;
(2) determining if a networked computer N is within a predetermined activity threshold;
(3) executing the process with the first networked computer if it is determined to be within the predetermined activity threshold; and
(4) repeating steps (2) to (4) with respect to networked computer N+1 if networked computer N is not within the predetermined activity threshold.

20. The method of claim 19 wherein instructions for executing the process are not sent to a networked computer until it is determined to be within the predetermined activity threshold.

21. The method of claim 19 wherein the predetermined activity threshold is at least partially based on expected network delays.

22. The method of claim 19 wherein the predetermined activity threshold is at least partially based on a time to reply to the predetermined activity threshold determination, a time to send the process request to the networked computer, and a time to execute the process.

23. The method of claim 20 wherein the predetermined activity threshold is at least partially based on an amount of data needed to send instructions for executing the process.

24. The method of claim 19 wherein the predetermined activity threshold is at least partially based on a current load of the networked computer.

25. A method for redundantly storing data among a plurality of networked computers in real time, the method comprising the steps of:
executing a process on a first computer, wherein the process amends, adds, and/or deletes data stored on the first computer;
determining if any of one or more of a second group of computers, other than the first computer, are within a predetermined activity threshold;
sending instructions to execute the process to each computer of the second group of computers determined to be within the predetermined activity threshold; and
placing instructions to execute the process in a queue for each computer in the second group of computers determined not to be within the predetermined activity threshold.

26. The method of claim 25 further comprising the step of
executing the queued process in the second group of computers determined not to be within the predetermined activity threshold if they return within a predetermined activity threshold before a predetermined length of time; and
replacing all data stored on the second group of computers determined not to be within the predetermined activity threshold with data stored on one of the plurality of networked computers that is within a predetermined activity threshold if the predetermined length of time has elapsed and processes remain in the queue.

27. The method of claim 25 wherein the predetermined activity threshold is at least partially based on expected network delays.

28. The method of claim 25 wherein the predetermined activity threshold is at least partially based on a time to reply to the predetermined activity threshold determination, a time to send the process request to the networked computer, and a time to execute the process.

29. The method of claim 27 wherein the predetermined activity threshold is at least partially based on a amount of data needed to send instructions for executing the process.

30. The method of claim 25 wherein the predetermined activity threshold is at least partially based on a current load of the networked computer.

31. A method for controlling entry to a location, the method comprising the steps of:
receiving a request for entry to a location, the request including identification information of a requester;
decrypting a database entry associated with the requester's identification information, wherein the database entry indicates whether or not the requester is allowed entry to the location;
allowing or denying entry based on the database entry.

32. The method of claim 31 wherein the database entry associated with the requester's identification information is the only database entry that is decrypted in response to the received request.

33. The method of claim 31 wherein the decrypting step stores the decrypted database entry in temporary memory.
